(19) United States
(12) Patent Application Publication
(10) Pub. No.: US 2025/0024464 A1
(43) Pub. Date: Jan. 16, 2025

(54) METHOD AND DEVICE IN NODES USED FOR WIRELESS COMMUNICATION

(71) Applicants: Qi JIANG, Shanghai (CN); Ping WANG, Shanghai (CN); Zheng LIU, Shanghai (CN); Xiaobo ZHANG, Shanghai (CN)

(72) Inventors: Qi JIANG, Shanghai (CN); Ping WANG, Shanghai (CN); Zheng LIU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/766,686

(22) Filed: Jul. 9, 2024

(30) Foreign Application Priority Data
Jul. 10, 2023 (CN) 202310841535.0

(51) Int. Cl. H04W 72/232; H04L 27/26

(52) U.S. Cl. CPC H04W 72/232; H04L 27/26025

(57) ABSTRACT

The first node receives a first DCI scheduling K1 cells; at least 2 cells among the K1 cells respectively correspond to subcarrier spacings that are unequal, K1 being a positive integer greater than 1; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs. This application is for the effective time.

### CROSS REFERENCE TO RELATED APPLICATIONS

This application claims the priority benefit of Chinese Patent Application No.202310841535.0, filed on July 10, 2023, the full disclosure of which is incorporated herein by reference.

### BACKGROUND

### Technical Field

The present application relates to transmission methods and devices in wireless communication systems, and in particular to a method and device for multicarrier communication in a wireless communication system supporting cellular networks.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

In existing NR systems, spectrum resources are statically divided into Frequency Division Duplexing (FDD) spectrum and Time Division Duplexing (TDD) spectrum. For TDD spectrum, both the base station and UE (i.e., User Equipment) operate in half-duplex mode. This half-duplex mode avoids self-interference and mitigates the effects of Cross Link Interference (CLI), but it also brings problems such as reduced resource utilization and increased latency. In view of these problems, to support flexible duplex mode or variable link directions (Uplink, or Downlink, or Flexible ones) on the TDD spectrum or the FDD spectrum becomes a potential solution. In the 3GPP RAN #88e meeting and the 3GPP Rel-18 (also referred to as Release-18 or version 18) workshop, the support of more flexible duplex mode or full duplex mode in NR Rel-18 has been widely noticed and discussed, especially the Subband non-overlapping Full Duplex (SBFD) mode at the gNB (NR node B) end. Communication in this mode is subject to severe interference, including self-interference and CLI. To solve the interference problem, advanced interference cancellation techniques are required, including antenna isolation, beamforming, RF (Radio Frequency) level interference cancellation and digital interference cancellation.

The multi-carrier (including Carrier Aggregation, abbreviated as CA, and Dual Connectivity, abbreviated as DC) techniques is an integral part of New Radio (NR) technology. To adapt to diverse application scenarios and meet different requests, the 3GPP has been working on the evolution of multi-carrier techniques since from the Rel-15 (Release-18).

### SUMMARY

In the multi-carrier communications, for instance Carrier Aggregation (CA), the system supports cross carrier scheduling. In networks supported by the existing standard, such as 5G New Radio (NR) in Rel-17 and of previous versions, for multiple scheduled carriers, scheduling is only supported to be provided on carriers or Physical Downlink Control Channels (PDCCHs) respectively corresponding to the carriers, rather than through a same PDCCH on a same carrier. Among discussions in Rel-18, the subject of multicarrier enhancement is on hot debate, and under this subject a PDCCH can schedule data channels on multiple carriers simultaneously to enhance the entire performance.

To address the issue that a same PDCCH schedules multiple carriers simultaneously in a multicarrier system in NR, the present application discloses a solution. It should be noted that although the original intent of this application is for SBFD scenarios, this application can also be applied to other non-SBFD scenarios; further, the adoption of a unified design scheme for different scenarios (e.g., other non-SBFD scenarios including, but not limited to, capacity augmentation systems, systems for near field communications, unlicensed spectrum communications, Internet of Things (IoT), Ultra Reliable Low Latency Communication (URLLC) networks, Vehicle-to-everything (V2X), etc.) also helps to reduce hardware complexity and cost. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

Particularly, for interpretations of the terminology; nouns, functions and variables (unless otherwise specified) in the present application, refer to definitions given in TS38 series and TS37 series of 3GPP specifications. Refer to 3GPP TS38.211, TS38.212, TS38.213, TS38.214, TS38.215, TS38.300, TS38.304, TS38.305, TS38.321, TS38.331, TS37.355, and TS38.423, if necessary, for a better understanding of the present application.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first DCI, the first DCI scheduling K1 cells;
herein, at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

In one embodiment, a problem to be solved in the present application includes: when a DCI schedules multiple cells at the same time, how to determine the effective time for a minimum applicable scheduling offset between the DCI and a channel scheduled on the plurality of cells.

In one embodiment, a problem to be solved in the present application includes: when a DCI schedules multiple cells at the same time, how to determine the effective time for a first minimum applicable scheduling offset between the DCI and a channel scheduled on at least one of the plurality of cells.

In one embodiment, characteristics of the above method include: when a DCI schedules multiple cells simultaneously, the present application makes the effective time for a minimum applicable scheduling offset between the DCI and a channel scheduled on the multiple cells dependent on a reception slot and a first offset value of the minimum applicable scheduling offset, thereby solving the above problem.

In one embodiment, characteristics of the above method include: when a DCI schedules multiple cells simultaneously, the present application makes the effective time for a minimum applicable scheduling offset between the DCI and a channel scheduled on at least one of the multiple cells dependent on a reception slot and a first offset value of the minimum applicable scheduling offset, thereby solving the above problem.

In one embodiment, characteristics of the above method include: an effective slot for the first minimum applicable scheduling offset, i.e. the second slot, which belongs to the time-domain resources of the cell being scheduled.

In one embodiment, characteristics of the above method include: the first minimum applicable scheduling offset is K₀ₘᵢₙ or K₂ₘᵢₙ, and the first minimum applicable scheduling offset is applicable to dynamic downlink scheduling or dynamic uplink scheduling.

In one embodiment, characteristics of the above method include: the physical layer dynamic signaling comprises a DCI, the DCI comprising a carrier indication field, the carrier indication field indicating at least the first cell.

In one embodiment, characteristics of the above method include: the physical layer dynamic signaling comprises a DCI, the DCI comprising a Minimum applicable scheduling offset indicator field, the Minimum applicable scheduling offset indicator field indicating a minimum applicable scheduling offset.

In one embodiment, characteristics of the above method include: the first offset value ensures that the UE is provided with an appropriate transition delay in both scenarios of switching from cross-slot scheduling to same-slot scheduling and switching from same-slot scheduling to cross-slot scheduling.

In one embodiment, the benefits of the above method include: in existing standards, when a DCI schedules a single cell and indicates a minimum applicable scheduling offset, the effective slot of the minimum applicable scheduling offset belongs to the time-domain resources of the scheduling cell, and the effective slot of the minimum applicable scheduling offset in the present application belongs to the time-domain resources of the cell being scheduled, which allows for better scheduling flexibility when scheduling multiple cells with a single DCI.

In one embodiment, the benefits of the above method include: supporting a scenario in which a DCI schedules multiple cells at the same time, and saving signaling overhead by eliminating the need for additional signaling to indicate the effective time of the first minimum applicable scheduling offset.

In one embodiment, the benefits of the above method include: supporting cross-slot scheduling with a DCI scheduling multiple cells, which facilitates energy saving by the UE.

In one embodiment, the benefits of the above method include: supporting a DCI to schedule multiple cells with different subcarrier spacing configurations at the same time, with good forward compatibility.

According to one aspect of the present application, the above method is characterized in that the second slot is delayed by the first offset value compared to a target slot, and a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one embodiment, characteristics of the above method comprise: the target slot belongs to the time-domain resources of the first cell.

In one embodiment, characteristics of the above method comprise: the first parameter is a carrier spacing parameter of an active BWP in which a PDSCH or PUSCH scheduled by the physical layer dynamic signaling is present.

In one embodiment, characteristics of the above method comprise: the second parameter is equal to a subcarrier spacing parameter of a subcarrier spacing employed for the physical layer dynamic signaling.

In one embodiment, the benefits of the above method include: an effective slot for the minimum value of the scheduling delay of the first cell occupies the time-domain resources of the first cell, thus the scheduling is more flexible.

According to one aspect of the present application, the above method is characterized in that a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

In one embodiment, characteristics of the above method include: effective slots for the first minimum applicable scheduling offset in the K1 cells respectively belong to the time-domain resources of the K1 scheduled cells.

In one embodiment, characteristics of the above method include: the K1 offset values ensure that the K1 cells being scheduled are provided with an appropriate transition delay in both scenarios of switching from cross-slot scheduling to same-slot scheduling and switching from same-slot scheduling to cross-slot scheduling.

In one embodiment, the benefits of the above method include: when a DCI schedules multiple cells, the effective slot for the minimum value of the scheduling delay varies with different scheduled cells, which provides greater scheduling flexibility while ensuring energy saving for the UE.

In one embodiment, the benefits of the above method include: supporting a DCI to schedule multiple cells with different subcarrier spacing configurations at the same time, with good forward compatibility.

In one embodiment, the benefits of the above method include: reducing data interruptions during the procedure of minimum scheduling delay switching in cross-slot scheduling.

According to one aspect of the present application, the above method is characterized in comprising:
receiving a first PDCCH;
herein, the first PDCCH is transmitted in the first slot, the first PDCCH being the physical layer dynamic signaling used to indicate the first minimum applicable adjustment offset; the first PDCCH is earlier than the first DCI in time domain

In one embodiment, characteristics of the above method include: the DCI transmitted in the first PDCCH is DCI format 0_N, N being a non-negative integer.

In one embodiment, characteristics of the above method include: the DCI transmitted in the first PDCCH is DCI format 1_N, N being a non-negative integer.

In one embodiment, characteristics of the above method include: the DCI transmitted in the first PDCCH comprises a Minimum applicable scheduling offset indicator field, the Minimum applicable scheduling offset indicator field being used to indicate the first minimum applicable scheduling offset.

In one embodiment, the benefits of the above method include: having good forward and backward compatibility.

According to one aspect of the present application, the above method is characterized in comprising:
receiving a first signal;
herein, the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset.

In one embodiment, characteristics of the above method include: the present application applies to scenarios where the format of the first DCI is DCI format 1_X, X being a positive integer greater than 2.

In one embodiment, characteristics of the above method include: the K1 first-type sub-signals each carries a different transport block (TB).

In one embodiment, characteristics of the above method include: the K1 first-type sub-signals respectively occupy K1 PDSCHs.

In one embodiment, the benefits of the above method include: supporting the BWPs in which the K1 PDSCHs are located to have different subcarrier spacing configurations, with good forward compatibility.

In one embodiment, the benefits of the above method include: supporting cross-slot scheduling with a DCI scheduling PDSCHs on multiple cells, which facilitates energy saving by the UE.

According to one aspect of the present application, the above method is characterized in comprising:
transmitting a second signal;
herein, the second signal comprises K1 second-type sub-signals, the K1 second-type sub-signals being transmitted in the Kl cells, respectively; the first DCI is used to schedule the second signal; a minimum value of a scheduling delay between each of the K1 second-type sub-signals and the first DCI is no smaller than the first minimum applicable scheduling offset.

In one embodiment, characteristics of the above method include: the present application applies to scenarios where the format of the first DCI is DCI format 0_X, X being a positive integer greater than 2.

In one embodiment, characteristics of the above method include: the K1 second-type sub-signals each carries a different transport block (TB).

In one embodiment, characteristics of the above method include: the K1 first-type sub-signals respectively occupy K1 PUSCHs.

In one embodiment, the benefits of the above method include: supporting the BWPs in which the K1 PUSCHs are located to have different subcarrier spacing configurations, with good forward compatibility.

In one embodiment, the benefits of the above method include: supporting cross-slot scheduling with a DCI scheduling PUSCHs on multiple cells, which facilitates energy saving by the UE.

According to one aspect of the present application, the above method is characterized in comprising:
receiving a first information block;
herein, the first information block indicates a first cell set, the first cell set comprising the K1 cells, the cells in the first cell set supporting scheduling by a DCI used to schedule multiple serving cells simultaneously.

In one embodiment, characteristics of the above method include: supporting one DCI in simultaneous scheduling of multiple serving cells.

In one embodiment, characteristics of the above method include: a first information block explicitly or implicitly indicates the first cell set.

In one embodiment, the benefits of the above method include: supporting enhanced multicarrier communications, saving spectrum resources and reducing signaling overheads.

According to one aspect of the present application, the above method is characterized in that the first node is a UE.

According to one aspect of the present application, the above method is characterized in that the first node is a relay node.

The present application provides a method in a second node for wireless communications, comprising:
transmitting a first DCI, the first DCI scheduling K1 cells;
herein, at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

According to one aspect of the present application, the above method is characterized in that the second slot is delayed by the first offset value compared to a target slot, and a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

According to one aspect of the present application, the above method is characterized in that a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

According to one aspect of the present application, the above method is characterized in comprising:
transmitting a first PDCCH;
herein, the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset.

According to one aspect of the present application, the above method is characterized in comprising:
transmitting a first signal;
herein, the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset.

According to one aspect of the present application, the above method is characterized in comprising:
receiving a second signal;
herein, the second signal comprises K1 second-type sub-signals, the K1 second-type sub-signals being transmitted in the K1 cells, respectively; the first DCI is used to schedule the second signal; a minimum value of a scheduling delay between each of the K1 second-type sub-signals and the first DCI is no smaller than the first minimum applicable scheduling offset.

According to one aspect of the present application, the above method is characterized in comprising:
transmitting a first information block;
herein, the first information block indicates a first cell set, the first cell set comprising the K1 cells, the cells in the first cell set supporting scheduling by a DCI used to schedule multiple serving cells simultaneously.

According to one aspect of the present application, the above method is characterized in that the second node is a base station.

According to one aspect of the present application, the above method is characterized in that the second node is a UE.

According to one aspect of the present application, the above method is characterized in that the second node is a relay node.

The present application provides a first node for wireless communications, comprising:
a first receiver, receiving a first DCI, the first DCI scheduling K1 cells;
herein, at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

The present application provides a second node for wireless communications, comprising:
a second transmitter, transmitting a first DCI, the first DCI scheduling K1 cells;
herein, at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

In one embodiment, compared with the prior art, the present application is advantageous in, but not limited to, the following aspects:
supporting scenarios where one DCI schedules multiple cells simultaneously, without additional signaling to indicate the effective time of the minimum applicable scheduling offset, thus saving signaling overhead;
supporting cross-slot scheduling with one DCI scheduling multiple cells, which is conducive to energy saving by the UE;
when a DCI schedules multiple cells, the effective slot for the minimum value of the scheduling delay varies with different scheduled cells, which provides greater scheduling flexibility while ensuring energy saving for the UE.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission between a first node and a second node according to one embodiment of the present application.

FIG. 6 illustrates a schematic diagram of a relation between a second slot and a target slot according to one embodiment of the present application.

FIG. 7 illustrates a schematic diagram of a relation between K1 first-type slots and a first slot according to one embodiment of the present application.

FIG. 8 illustrates a schematic diagram of a first signal according to one embodiment of the present application.

FIG. 9 illustrates a schematic diagram of a second signal according to one embodiment of the present application.

FIG. 10 illustrates a structure block diagram of a processing device used in a first node according to one embodiment of the present application.

FIG. 11 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

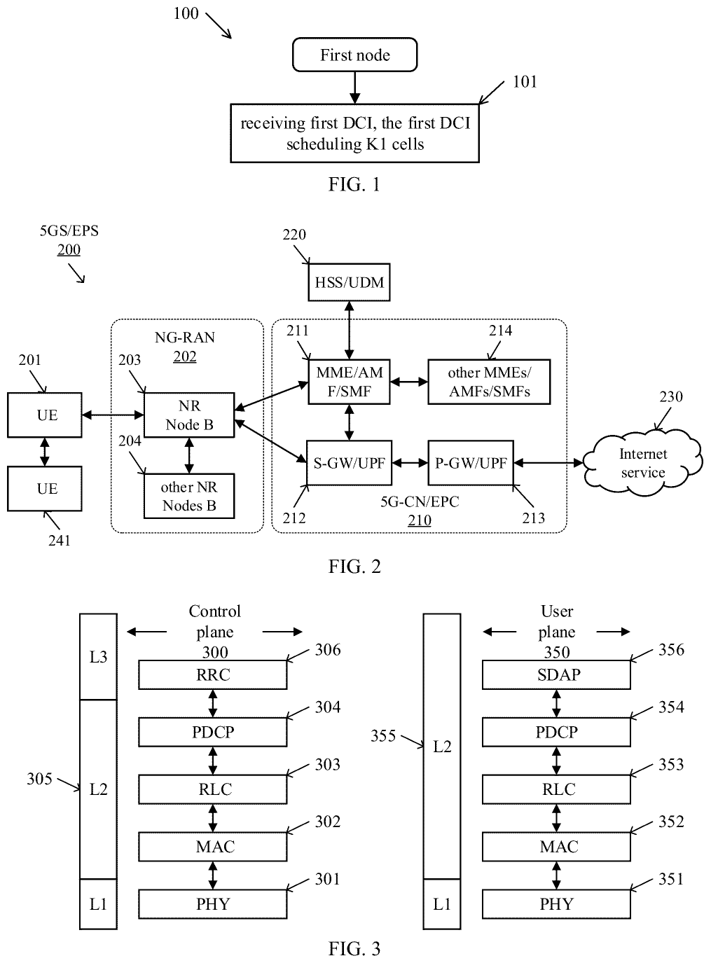

Embodiment 1 illustrates a flowchart of transmission of a first node according to one embodiment of the present application, as shown in FIG. 1. In FIG. 1, each box represents a step. Particularly, the sequential step arrangement in each box herein does not imply a chronological order of steps marked respectively by these boxes.

The first node receives a first DCI in step 101, the first DCI scheduling K1 cells.

In Embodiment 1, at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

In one embodiment, the DCI refers to Downlink Control Information.

In one embodiment, the first node receives the first DCI.

In one embodiment, a format of the first DCI is one of DCI Formats supported by a UE-Specific Search set (USS set).

In one embodiment, the first node monitors the first DCI in the USS set.

In one embodiment, the meaning of the monitoring includes to detect.

In one embodiment, the meaning of the monitoring includes to receive.

In one embodiment, the meaning of the monitoring includes to search.

In one embodiment, the meaning of the monitoring includes to monitor.

In one embodiment, the meaning of the monitoring includes to check by means of Cyclic Redundancy Check (CRC).

In one embodiment, the format of the first DCI is a DCI format for scheduling uplink channels or signals.

In one embodiment, the format of the first DCI is DCI format 0_X, X being a positive integer greater than 2.

In one embodiment, the format of the first DCI is a DCI format for scheduling downlink channels or signals.

In one embodiment, the format of the first DCI is DCI format 1_X, X being a positive integer greater than 2.

In one embodiment, CRC of the first DCI is scrambled by a Modulation and Coding Scheme-Cell-Radio Network Temporary Identifier (MCS-C-RNTI).

In one embodiment, the CRC of the first DCI is scrambled by a Cell-RNTI (C-RNTI).

In one subembodiment, the C-RNTI is associated to the first node and one of the K1 cells.

In one subembodiment, the C-RNTI is associated to the first node and a cell other than the K1 cells.

In one subembodiment, the C-RNTI is a C-RNTI of the first node in one of the K1 cells.

In one subembodiment, the C-RNTI is a C-RNTI of the first node in a cell other than the K1 cells.

In one embodiment, K1 is greater than 1.

In one embodiment, K1 is no greater than 4.

In one embodiment, K1 is no greater than 8.

In one embodiment, K1 is no greater than 32.

In one embodiment, the K1 cells are K1 serving cells respectively.

In one embodiment, each of the K1 cells is a serving cell of the first node.

In one embodiment, the first node performs Secondary Serving Cell Addition for each of the K1 cells.

In one embodiment, a latest sCellToAddModList or sCellToAddModListSCG received by the first node comprises each of the K1 cells.

In one embodiment, for each of the K1 cells, the first node is assigned an SCellIndex or ServCellIndex for this cell.

In one embodiment, a Radio Resource Control (RRC) connection has been established between the first node and each of the K1 cells.

In one embodiment, the K1 cells include a Special Cell (SpCell) of the first node.

In one embodiment, the K1 cells include a Secondary Cell (SCell) of the first node.

In one embodiment, any of the K1 cells is a SpCell or SCell of the first node.

In one embodiment, the serving cell is defined in 3GPP (i.e., the 3rd Generation Partner Project) TS (i.e., Technical Specification) 38.331.

In one embodiment, the K1 cells correspond to K1 ServCellIndexes, respectively.

In one embodiment, the K1 cells correspond to K1 servCellIds, respectively.

In one embodiment, the K1 cells correspond to K1 scheduledCellIds, respectively.

In one embodiment, the K1 cells correspond to K1 Carrier Indicator Fields (CIFs), respectively.

In one embodiment, the K1 cells correspond to K1 PhysCellIds, respectively.

In one embodiment, the K1 cells correspond to K1 PCIs, respectively.

In one embodiment, the PCI in this application refers to: Physical Cell Identifier.

In one embodiment, the PCI in this application refers to: Physical Cell Identity.

In one embodiment, the PCI in this application refers to: Physical-layer Cell Identity.

In one embodiment, the K1 cells respectively correspond to K1 Component Carriers (CCs).

In one embodiment, the K1 cells correspond to K1 carriers, respectively.

In one subembodiment, the K1 carriers are respectively K1 carriers corresponding to the K1 cells scheduled by the first DCI.

In one subembodiment, the K1 carriers are respectively K1 UpLink (UL) carriers corresponding to the K1 cells scheduled by the first DCI.

In one subembodiment, the K1 carriers are respectively K1 DownLink (DL) carriers of the K1 cells scheduled by the first DCI.

In one embodiment, the UL carrier in the present application comprises a Normal Uplink (NUL) carrier.

In one embodiment, the UL carrier in the present application comprises a Supplementary UL (SUL) carrier.

In one embodiment, the K1 cells correspond to K1 active BandWidth Parts (BWPs), respectively.

In one subembodiment, the K1 active BWPs are respectively BWPs in the K1 cells that are scheduled by the first DCI.

In one subembodiment, the K1 active BWPs are respectively UL BWPs in the K1 cells that are scheduled by the first DCI.

In one subembodiment, the K1 active BWPs are respectively DL BWPs in the K1 cells that are scheduled by the first DCI.

In one embodiment, the K1 cells all belong to a same cell group.

In one embodiment, the K1 cells all belong to a Master Cell Group (MCG) or a Secondary Cell Group (SCG).

In one embodiment, the K1 cells all belong to a same Physical Uplink Control CHannel (PUCCH) group.

In one embodiment, a PUCCH group comprises a group of cells, where a PUCCH signaling of the group of cells is associated with a PUCCH of a SpCell, or is associated with a PUCCH of a PUCCH SCell; a PUCCH SCell is a SCell configured with a PUCCH.

In one embodiment, a PUCCH group comprises a group of cells, a PUCCH signaling of the group of cells being associated with a PUCCH of the same cell.

In one subembodiment, a PUCCH carrying the PUCCH signaling for the group of cells is transmitted in the same cell.

In one subembodiment, a PUCCH carrying the PUCCH signaling for the group of cells is a PUCCH that is configured for the same cell.

In one subembodiment, the same cell is a PUCCH cell of the group of cells.

In one subembodiment, the same cell is a SpCell or PUCCH SCell of the group of cells.

In one subembodiment, the same cell is a cell in the group of cells that is configured with a PUCCH.

In one subembodiment, the same cell is a cell in the group of cells that is uniquely configured with a PUCCH.

In one embodiment, the PUCCH group is defined in 3GPP TS38.300 and 3GPP TS38.331.

In one embodiment, the PUCCH SCell is defined in 3GPP TS38.300 and 3GPP TS38.331.

In one embodiment, the first node receives the first DCI on one of the K1 cells.

In one embodiment, the first node receives the first DCI on a cell other than the K1 cells.

In one embodiment, the first DCI schedules the K1 cells.

In one embodiment, the first DCI schedules transmission of radio signals in the K1 cells.

In one embodiment, the first DCI schedules reception of radio signals in the K1 cells.

In one embodiment, the first DCI schedules K1 channels, the K1 channels being transmitted by the first node in the K1 cells, respectively.

In one embodiment, the first DCI schedules K1 channels, the K1 channels being sent by the first node in the K1 cells, respectively.

In one embodiment, the first DCI schedules K1 channels, the K1 channels being received by the first node in the K1 cells, respectively.

In one embodiment, the action “a channel (or a signal) is transmitted (or sent or received) by a node on a cell” comprises: the node transmits (or sends or receives) the signal using an air interface resource of the cell.

In one embodiment, the action “a channel (or a signal) is transmitted (or sent or received) by a node on a cell” comprises: the node transmits (or sends or receives) the signal in an air interface resource corresponding to the cell.

In one embodiment, the action “a channel (or a signal) is transmitted (or sent or received) by a node on a cell” comprises: the node transmits (or sends or receives) the signal in an air interface resource configured for the cell.

In one embodiment, the air interface resource in this application comprises a frequency-domain resource.

In one embodiment, the air interface resource in this application comprises a time-domain resource.

In one embodiment, the air interface resource in this application comprises a code-domain resource.

In one embodiment, the air interface resource in this application comprises a spatial resource.

In one embodiment, the first DCI schedules K1 channels, the K1 channels being transmitted in the K1 active BWPs in the K1 cells, respectively.

In one embodiment, the first DCI schedules K1 channels, the K1 channels being sent in the K1 active UL BWPs in the K1 cells, respectively.

In one embodiment, the first DCI schedules K1 channels, the K1 channels being received in the K1 active DL BWPs in the K1 cells, respectively.

In one embodiment, at least two cells among the K1 cells respectively correspond to unequal subcarrier spacings.

In one embodiment, “at least two cells among the K1 cells respectively correspond to unequal subcarrier spacings” means that at least 2 of the K1 cells are configured with different SubCarrier Spacings (SCS).

In one embodiment, “at least two cells among the K1 cells respectively correspond to unequal subcarrier spacings” means that at least two of the K1 cells use different subcarrier spacings.

In one embodiment, “at least two cells among the K1 cells respectively correspond to unequal subcarrier spacings” means that all of the K1 cells are configured with different subcarrier spacings.

In one embodiment, “at least two cells among the K1 cells respectively correspond to unequal subcarrier spacings” means that all of the K1 cells use different subcarrier spacings.

In one embodiment, “at least two cells among the K1 cells respectively correspond to unequal subcarrier spacings” means that there are two cells among the K1 cells being configured with the same subcarrier spacing.

In one embodiment, “at least two cells among the K1 cells respectively correspond to unequal subcarrier spacings” means that there are two cells among the K1 cells using the same subcarrier spacing.

In one embodiment, “at least two cells among the K1 cells respectively correspond to unequal subcarrier spacings” means that 2 active BWPs in at least two of the K1 cells are configured with different SubCarrier Spacings (SCS).

In one embodiment, “at least two cells among the K1 cells respectively correspond to unequal subcarrier spacings” means that 2 active BWPs in at least two of the K1 cells use different SubCarrier Spacings (SCS).

In one embodiment, “at least two cells among the K1 cells respectively correspond to unequal subcarrier spacings” means that active BWPs in all of the K1 cells are configured with different subcarrier spacings.

In one embodiment, “at least two cells among the K1 cells respectively correspond to unequal subcarrier spacings” means that active BWPs in all of the K1 cells use different subcarrier spacings.

In one embodiment, “at least two cells among the K1 cells respectively correspond to unequal subcarrier spacings” means that there are at least two of the K1 cells in which 2 active BWPs are configured with the same SubCarrier Spacing (SCS).

In one embodiment, “at least two cells among the K1 cells respectively correspond to unequal subcarrier spacings” means that there are at least two of the K1 cells in which 2 active BWPs use the same SubCarrier Spacing (SCS).

In one embodiment, the first minimum applicable scheduling offset is K₀ₘᵢₙ.

In one embodiment, the first minimum applicable scheduling offset is K₂ₘᵢₙ.

In one embodiment, the first minimum applicable scheduling offset is K₀ₘᵢₙ for the first cell.

In one embodiment, the first minimum applicable scheduling offset is K₂ₘᵢₙ for the first cell.

In one embodiment, the first minimum applicable scheduling offset is K₀ₘᵢₙ on the active BWP of the first cell.

In one embodiment, the first minimum applicable scheduling offset is K₂ₘᵢₙ on the active BWP of the first cell.

In one embodiment, the first minimum applicable scheduling offset is K₀ₘᵢₙ for the cell to which the first DCI belongs.

In one embodiment, the first minimum applicable scheduling offset is K₂ₘᵢₙ for the cell to which the first DCI belongs.

In one embodiment, the first minimum applicable scheduling offset is K₀ₘᵢₙ on the active BWP of the cell to which the first DCI belongs.

In one embodiment, the first minimum applicable scheduling offset is K₂ₘᵢₙ on the active BWP of the cell to which the first DCI belongs.

In one embodiment, the first minimum applicable scheduling offset is a greatest value of K₀ₘᵢₙ corresponding to the K1 cells.

In one embodiment, the first minimum applicable scheduling offset is a greatest value of K₂ₘᵢₙ corresponding to the K1 cells.

In one embodiment, the first minimum applicable scheduling offset is a smallest value of K₀ₘᵢₙ corresponding to the K1 cells.

In one embodiment, the first minimum applicable scheduling offset is a smallest value of K₂ₘᵢₙ corresponding to the K1 cells.

In one embodiment, the first minimum applicable scheduling offset is a greatest value of K₀ₘᵢₙ on active BWPs of all of the K1 cells.

In one embodiment, the first minimum applicable scheduling offset is a greatest value of K₂ₘᵢₙ on active BWPs of all of the K1 cells.

In one embodiment, the first minimum applicable scheduling offset is a smallest value of K₀ₘᵢₙ on active BWPs of all of the K1 cells.

In one embodiment, the first minimum applicable scheduling offset is a smallest value of K₂ₘᵢₙ on active BWPs of all of the K1 cells.

In one embodiment, a minimum value of a scheduling delay between the channel scheduled by the first DCI and the first DCI in at least one of the K1 cells is not less than the first minimum applicable scheduling offset.

In one embodiment, a minimum value of a scheduling delay between the channel scheduled by the first DCI and the first DCI in each of the K1 cells is not less than the first minimum applicable scheduling offset.

In one embodiment, there is one of the K1 cells in which a minimum value of a scheduling delay between the channel scheduled by the first DCI and the first DCI is not less than the first minimum applicable scheduling offset.

In one embodiment, there is at least one of the K1 cells in which a minimum value of a scheduling delay between the channel scheduled by the first DCI and the first DCI is not less than the first minimum applicable scheduling offset.

In one embodiment, there is one of the K1 cells in which a minimum value of a scheduling delay between the channel scheduled by the first DCI and the first DCI is less than the first minimum applicable scheduling offset.

In one embodiment, a minimum value of a scheduling delay between the channel scheduled by the first DCI and the first DCI in at least one of the K1 cells is greater than the first minimum applicable scheduling offset.

In one embodiment, a minimum value of a scheduling delay between the channel scheduled by the first DCI and the first DCI in each of the K1 cells is greater than the first minimum applicable scheduling offset.

In one embodiment, there is one of the K1 cells in which a minimum value of a scheduling delay between the channel scheduled by the first DCI and the first DCI is greater than the first minimum applicable scheduling offset.

In one embodiment, there is at least one of the K1 cells in which a minimum value of a scheduling delay between the channel scheduled by the first DCI and the first DCI is greater than the first minimum applicable scheduling offset.

In one embodiment, there is one of the K1 cells in which a minimum value of a scheduling delay between the channel scheduled by the first DCI and the first DCI is not greater than the first minimum applicable scheduling offset.

In one embodiment, a minimum value of a scheduling delay between the channel scheduled by the first DCI and the first DCI in at least one of the K1 cells is equal to the first minimum applicable scheduling offset.

In one embodiment, a minimum value of a scheduling delay between the channel scheduled by the first DCI and the first DCI in each of the K1 cells is equal to the first minimum applicable scheduling offset.

In one embodiment, there is one of the K1 cells in which a minimum value of a scheduling delay between the channel scheduled by the first DCI and the first DCI is equal to the first minimum applicable scheduling offset.

In one embodiment, there is one of the K1 cells in which a minimum value of a scheduling delay between the channel scheduled by the first DCI and the first DCI is not equal to the first minimum applicable scheduling offset.

In one embodiment, “a minimum value of a scheduling delay between a channel scheduled by the first DCI and the first DCI in at least one cell among the K1 cells depends on a first minimum applicable scheduling offset” means that the first node will not expect a scheduling delay between a channel scheduled by the first DCI in at least one of the K1 cells and the first DCI to be smaller than the first minimum applicable scheduling offset.

In one embodiment, “a minimum value of a scheduling delay between a channel scheduled by the first DCI and the first DCI in at least one cell among the K1 cells depends on a first minimum applicable scheduling offset” means that the first node will not expect the presence of one cell among the K1 cells in which a scheduling delay between a channel scheduled by the first DCI and the first DCI is smaller than the first minimum applicable scheduling offset.

In one embodiment, “a minimum value of a scheduling delay between a channel scheduled by the first DCI and the first DCI in at least one cell among the K1 cells depends on a first minimum applicable scheduling offset” means that the first node assumes a scheduling delay between a channel scheduled by the first DCI in at least one of the K1 cells and the first DCI to be not smaller than the first minimum applicable scheduling offset.

In one embodiment, “a minimum value of a scheduling delay between a channel scheduled by the first DCI and the first DCI in at least one cell among the K1 cells depends on a first minimum applicable scheduling offset” means that the first node assumes a scheduling delay between a channel scheduled by the first DCI in each of the K1 cells and the first DCI to be not smaller than the first minimum applicable scheduling offset.

In one embodiment, the first slot is a slot.

Typically, a slot consists of 14 consecutive symbols.

In one embodiment, the first slot is a downlink slot.

In one embodiment, the first slot is a flexible slot.

In one embodiment, the first slot comprises at least one downlink symbol.

In one embodiment, the first slot occupies time-domain resources of the cell to which the physical layer dynamic signaling belongs.

In one embodiment, the first slot belongs to time-domain resources of the cell to which the physical layer dynamic signaling belongs.

In one embodiment, the first slot occupies time-domain resources configured by the cell to which the physical layer dynamic signaling belongs.

In one embodiment, the first slot belongs to time-domain resources configured by the cell to which the physical layer dynamic signaling belongs.

In one embodiment, the first slot occupies time-domain resources corresponding to the cell to which the physical layer dynamic signaling belongs.

In one embodiment, the first slot belongs to time-domain resources corresponding to the cell to which the physical layer dynamic signaling belongs.

In one embodiment, the first node receives the physical layer dynamic signaling in the first slot.

In one embodiment, the first node receives the physical layer dynamic signaling on at least one symbol in the first slot.

In one embodiment, the first node receives the physical layer dynamic signaling on one symbol in the first slot.

In one embodiment, the first node receives the physical layer dynamic signaling on multiple consecutive symbols in the first slot.

In one embodiment, the first node receives the physical layer dynamic signaling on at least one symbol within the first three symbols in the first slot.

In one embodiment, the first node receives the physical layer dynamic signaling on one symbol within the first three symbols in the first slot.

In one embodiment, the first node receives the physical layer dynamic signaling on multiple contiguous symbols within the first three symbols in the first slot.

In one embodiment, the first node receives the physical layer dynamic signaling on at least one symbol outside the first three symbols in the first slot.

In one embodiment, the first node receives the physical layer dynamic signaling on one symbol outside the first three symbols in the first slot.

In one embodiment, the first node receives the physical layer dynamic signaling on multiple contiguous symbols outside the first three symbols in the first slot.

In one embodiment, the first minimum applicable scheduling offset is indicated via the physical layer dynamic signaling in the first slot.

In one embodiment, the physical layer dynamic signaling indicates the first minimum applicable scheduling offset.

In one embodiment, the physical layer dynamic signaling explicitly indicates the first minimum applicable scheduling offset.

In one embodiment, the physical layer dynamic signaling implicitly indicates the first minimum applicable scheduling offset.

In one embodiment, the explicit indicating includes indicating directly by means of a value of a bit field.

In one embodiment, the implicit indicating includes indirectly indicating by means of indication of other IEs comprising a minimum applicable scheduling offset.

In one embodiment, the first minimum applicable scheduling offset is received via the physical layer dynamic signaling in the first slot, the physical layer dynamic signaling comprising a second DCI, the second DCI being received by the first node prior to the first DCI.

In one embodiment, the first minimum applicable scheduling offset is received via the physical layer dynamic signaling in the first slot, the physical layer channel occupied by the physical layer dynamic signaling including a PDCCH.

In one embodiment, the first minimum applicable scheduling offset is received via the physical layer dynamic signaling in the first slot, the physical layer dynamic signaling comprising the first DCI, the first DCI indicating that the first minimum scheduling offset takes effect in at least one of the K1 cells.

In one embodiment, the first cell is a serving cell of the first node.

In one embodiment, the first node performs Secondary Serving Cell Addition for the first cell.

In one embodiment, a latest sCellToAddModList or sCellToAddModListSCG received by the first node comprises the first cell.

In one embodiment, the first node is assigned an SCellIndex or ServCellIndex for the first cell.

In one embodiment, an RRC connection has been established between the first node and the first cell.

In one embodiment, the first cell is a SpCell or SCell of the first node.

In one embodiment, the CRC of the first DCI is scrambled by a C-RNTI, the C-RNTI being associated to the first node and the first cell.

In one embodiment, the CRC of the first DCI is scrambled by a C-RNTI, the C-RNTI being associated to the first node and a cell other than the first cell.

In one embodiment, the CRC of the first DCI is scrambled by a C-RNTI, the C-RNTI being a C-RNTI of the first node in the first cell.

In one embodiment, the CRC of the first DCI is scrambled by a C-RNTI, the C-RNTI being a C-RNTI of the first node in a cell other than the first cell.

In one embodiment, the first cell corresponds to a ServCellIndex.

In one embodiment, the first cell corresponds to a servCellId.

In one embodiment, the first cell corresponds to a scheduledCellId.

In one embodiment, the first cell corresponds to a CIF.

In one embodiment, the first cell corresponds to a PhysCellId.

In one embodiment, the first cell corresponds to a PCI.

In one embodiment, the first cell corresponds to a CC.

In one embodiment, the first cell corresponds to a Carrier.

In one embodiment, the first cell corresponds to a BWP.

In one embodiment, the first cell is not the same as the cell to which the physical layer dynamic signaling belongs.

In one embodiment, the first slot does not occupy time-domain resources of the first cell.

In one embodiment, the first slot does not occupy time-domain resources configured by the first cell.

In one embodiment, the first slot does not occupy time-domain resources corresponding to the first cell.

In one embodiment, the first slot does not belong to time-domain resources of the first cell.

In one embodiment, the first slot does not belong to time-domain resources configured by the first cell.

In one embodiment, the first slot does not belong to time-domain resources corresponding to the first cell.

In one embodiment, time-domain resources occupied by the first slot do not belong to the first cell.

In one embodiment, the first slot is not indexed according to an SCS of the first cell.

In one embodiment, the first node does not receive the physical layer dynamic signaling in air interface resources of the first cell.

In one embodiment, the first node does not receive the physical layer dynamic signaling in air interface resources corresponding to the first cell.

In one embodiment, the first node does not receive the physical layer dynamic signaling in air interface resources configured by the first cell.

In one embodiment, the physical layer dynamic signaling comprises a DCI, the CRC of the DCI being scrambled by a C-RNTI.

In one subembodiment, the DCI is the first DCI.

In one subembodiment, the DCI is a DCI other than the first DCI.

In one subembodiment, the DCI is the second DCI in this application.

In one subembodiment, the C-RNTI is associated to the first node and a cell other than the first cell.

In one subembodiment, the C-RNTI is a C-RNTI of the first node in a cell other than the first cell.

In one embodiment, the second slot is a slot.

In one embodiment, the second slot is an uplink slot.

In one embodiment, the second slot is a downlink slot.

In one embodiment, the second slot is a flexible slot.

In one embodiment, the second slot occupies time-domain resources of the first cell.

In one embodiment, the second slot occupies time-domain resources configured by the first cell.

In one embodiment, the second slot occupies time-domain resources corresponding to the first cell.

In one embodiment, the second slot belongs to time-domain resources of the first cell.

In one embodiment, the second slot belongs to time-domain resources configured by the first cell.

In one embodiment, the second slot belongs to time-domain resources corresponding to the first cell.

In one embodiment, “the first minimum applicable scheduling offset applying to the first cell starting from a second slot of the first cell” means that the first minimum applicable scheduling offset is in effect in the first cell from the second slot in the first cell.

In one embodiment, “the first minimum applicable scheduling offset applying to the first cell starting from a second slot of the first cell” means that the first minimum applicable scheduling offset is in effect in scheduling of the first cell from the second slot in the first cell.

In one embodiment, the second slot depends on the first slot and the first offset value.

In one embodiment, the second slot is delayed by the first offset value compared to a target slot; and a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one subembodiment, the first ratio is equal to

$$\frac{{2}^{μ} PDSCH}{{2}^{μ} PDCCH} ,$$

where μ_{PDSCH} is the first parameter and μ_{PDCCH} is the second parameter.

In one subembodiment, the first value is equal to

$$n \cdot \frac{{2}^{μ} PDSCH}{{2}^{μ} PDCCH} ,$$

where n corresponds to the slot index corresponding to the first slot in the cell to which the physical layer dynamic signaling belongs, μ_{PDSCH} is the first parameter, and μ_{PDCCH} is the second parameter.

In one subembodiment, the slot index corresponding to the target slot is equal to

$$⌊ n \cdot \frac{{2}^{μ} PDSCH}{{2}^{μ} PDCCH} ⌋ ,$$

where n corresponds to the slot index corresponding to the first slot in the cell to which the physical layer dynamic signaling belongs, μ_{PDSCH} is the first parameter and μ_{PDCCH} is the second parameter.

In one subembodiment, the slot index corresponding to the second slot is equal to

$$⌊ n \cdot \frac{{2}^{μ} PDSCH}{{2}^{μ} PDCCH} ⌋ + the first offset value ,$$

where n corresponds to the slot index corresponding to the first slot in the cell to which the physical layer dynamic signaling belongs, μ_{PDSCH} is the first parameter and μ_{PDCCH} is the second parameter.

In one subembodiment, the first offset value is equal to a greater value between the currently applicable K₀ₘᵢₙ for the first cell and a first integer; the first integer is dependent on the subcarrier spacing corresponding to the first cell and the position of a symbol occupied by the physical layer dynamic signaling in the first slot.

In one subsidiary embodiment of the above subembodiment, when the first node receives the physical layer dynamic signaling on at least one symbol within the first three symbols in the first slot, the subcarrier spacing corresponding to the first cell is 15 kHz and the first integer is equal to 1; the subcarrier spacing corresponding to the first cell is 30 KHz and the first integer is equal to 1; the subcarrier spacing corresponding to the first cell is 60 kHz and the first integer is equal to 2; the subcarrier spacing corresponding to the first cell is 120 kHz and the first integer is equal to 2; the subcarrier spacing corresponding to the first cell is 480 kHz and the first integer is equal to 8; the subcarrier spacing corresponding to the first cell is 960 kHz and the first integer is equal to 16.

In one subsidiary embodiment of the above subembodiment, when the first node receives the physical layer dynamic signaling on at least one symbol outside the first three symbols in the first slot, the subcarrier spacing corresponding to the first cell is 15 kHz and the first integer is equal to 2; the subcarrier spacing corresponding to the first cell is 30 kHz and the first integer is equal to 2; the subcarrier spacing corresponding to the first cell is 60 kHz and the first integer is equal to 3; the subcarrier spacing corresponding to the first cell is 120 kHz and the first integer is equal to 3; the subcarrier spacing corresponding to the first cell is 480 kHz and the first integer is equal to 9; the subcarrier spacing corresponding to the first cell is 960 kHz and the first integer is equal to 17.

In one subembodiment, the first offset value is equal to a greater value between the currently applicable K₀ₘᵢₙ for the first cell and a second value, the second value being a largest integer not greater than a second integer multiplied by the first ratio, the second integer being dependent on the subcarrier spacing employed by the cell to which the physical layer dynamic signaling belongs and the position of the symbol occupied by the physical layer dynamic signaling in the first slot.

In one subsidiary embodiment of the above subembodiment, when the first node receives the physical layer dynamic signaling on at least one symbol within the first three symbols in the first slot, the subcarrier spacing used by the cell to which the physical layer dynamic signaling belongs is 15 kHz, the second integer being equal to 1; the subcarrier spacing used by the cell to which the physical layer dynamic signaling belongs is 30 kHz, the second integer being equal to 1; the subcarrier spacing used by the cell to which the physical layer dynamic signaling belongs is 60 kHz, the second integer being equal to 2; the subcarrier spacing used by the cell to which the physical layer dynamic signaling belongs is 120 kHz, the second integer being equal to 2; the subcarrier spacing used by the cell to which the physical layer dynamic signaling belongs is 480 kHz, the second integer being equal to 8; the subcarrier spacing used by the cell to which the physical layer dynamic signaling belongs is 960 kHz, the second integer being equal to 16.

In one subsidiary embodiment of the above subembodiment, when the first node receives the physical layer dynamic signaling on at least one symbol outside the first three symbols in the first slot, the subcarrier spacing used by the cell to which the physical layer dynamic signaling belongs is 15 kHz, the second integer being equal to 2; the subcarrier spacing used by the cell to which the physical layer dynamic signaling belongs is 30 kHz, the second integer being equal to 2; the subcarrier spacing used by the cell to which the physical layer dynamic signaling belongs is 60 kHz, the second integer being equal to 3; the subcarrier spacing used by the cell to which the physical layer dynamic signaling belongs is 120 kHz, the second integer being equal to 3; the subcarrier spacing used by the cell to which the physical layer dynamic signaling belongs is 480 kHz, the second integer being equal to 9; the subcarrier spacing used by the cell to which the physical layer dynamic signaling belongs is 960 kHz, the second integer being equal to 17.

In one embodiment, a third slot is delayed by the first offset value compared to the first slot, and a slot index corresponding to the second slot is a maximum integer no greater than a third value, the third value being equal to a product of the slot index corresponding to the third slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one subembodiment, the index corresponding to the third slot is equal to n+the first offset value, where n corresponds to a corresponding slot index of the first slot in the cell to which the physical layer dynamic signaling belongs.

In one subembodiment, the first ratio is equal to

$$\frac{{2}^{μ} PDSCH}{{2}^{μ} PDCCH} ,$$

where μ_{PDSCH} is the first parameter and μ_{PDCCH} is the second parameter.

In one subembodiment, the third value is equal to

$$( n + the first offset value ) \cdot \frac{{2}^{μ} PDSCH}{{2}^{μ} PDCCH} ,$$

where n corresponds to the slot index corresponding to the first slot in the cell to which the physical layer dynamic signaling belongs, μ_{PDSCH} is the first parameter, and μ_{PDCCH} is the second parameter.

In one subembodiment, the slot index corresponding to the second slot is equal to

$$⌊ ( n + the first offset value ) \cdot \frac{{2}^{μ} PDSCH}{{2}^{μ} PDCCH} ⌋ ,$$

where n corresponds to the slot index corresponding to the first slot in the cell to which the physical layer dynamic signaling belongs, μ_{PDSCH} is the first parameter and μ_{PDCCH} is the second parameter.

In one subembodiment, the first offset value is equal to a greatest value among all of the currently applicable K₀ₘᵢₙₛ for the K1 cells and a third integer, the third integer being dependent on the subcarrier spacing employed by the cell to which the physical layer dynamic signaling belongs and the position of the symbol occupied by the physical layer dynamic signaling in the first slot.

In one subembodiment, the first offset value is equal to a greater value between the smallest of all of the currently applicable K₀ₘᵢₙₛ for the K1 cells and a third integer, the third integer being dependent on the subcarrier spacing employed by the cell to which the physical layer dynamic signaling belongs and the position of the symbol occupied by the physical layer dynamic signaling in the first slot.

In one subsidiary embodiment of the above two subembodiments, when the first node receives the physical layer dynamic signaling on at least one symbol within the first three symbols in the first slot, the subcarrier spacing used by the cell to which the physical layer dynamic signaling belongs is 15 kHz, the second integer being equal to 1; the subcarrier spacing used by the cell to which the physical layer dynamic signaling belongs is 30 kHz, the second integer being equal to 1; the subcarrier spacing used by the cell to which the physical layer dynamic signaling belongs is 60 kHz, the second integer being equal to 2; the subcarrier spacing used by the cell to which the physical layer dynamic signaling belongs is 120 kHz, the second integer being equal to 2; the subcarrier spacing used by the cell to which the physical layer dynamic signaling belongs is 480 kHz, the second integer being equal to 8; the subcarrier spacing used by the cell to which the physical layer dynamic signaling belongs is 960 kHz, the second integer being equal to 16.

In one subsidiary embodiment of the above two subembodiments, when the first node receives the

physical layer dynamic signaling on at least one symbol outside the first three symbols in the first slot, the subcarrier spacing used by the cell to which the physical layer dynamic signaling belongs is 15 kHz, the second integer being equal to 2; the subcarrier spacing used by the cell to which the physical layer dynamic signaling belongs is 30 kHz, the second integer being equal to 2; the subcarrier spacing used by the cell to which the physical layer dynamic signaling belongs is 60 kHz, the second integer being equal to 3; the subcarrier spacing used by the cell to which the physical layer dynamic signaling belongs is 120 kHz, the second integer being equal to 3; the subcarrier spacing used by the cell to which the physical layer dynamic signaling belongs is 480 kHz, the second integer being equal to 9; the subcarrier spacing used by the cell to which the physical layer dynamic signaling belongs is 960 kHz, the second integer being equal to 17.

In one subembodiment, the first offset value is equal to a greatest value among all of the currently applicable K₀ₘᵢₙₛ for the K1 cells and K1 switching integers; the K1 switching integers are respectively dependent on the subcarrier spacings employed by the K1 cells and the position of a symbol occupied by the physical layer dynamic signaling in the first slot.

In one subembodiment, the first offset value is equal to a smallest value among K1 values, the K1 values respectively being K1 greater values between K1 respectively applicable K₀ₘᵢₙₛ in the K1 cells and K1 switching integers; the K1 switching integers are respectively dependent on the subcarrier spacings employed by the K1 cells and the position of a symbol occupied by the physical layer dynamic signaling in the first slot.

In one subsidiary embodiment of the above two subembodiments, any of the K1 switching integers is a target switching integer, and the cell corresponding to the target switching integer is a target cell; when the first node receives the physical layer dynamic signaling on at least one symbol within the first three symbols in the first slot, the subcarrier spacing used by the target cell is 15 kHz, the target switching integer being equal to 1; the subcarrier spacing used by the target cell is 30 kHz, the target switching integer being equal to 1; the subcarrier spacing used by the target cell is 60 kHz, the target switching integer being equal to 2; the subcarrier spacing used by the target cell is 120 kHz, the target switching integer being equal to 2; the subcarrier spacing used by the target cell is 480 kHz, the target switching integer being equal to 8; the subcarrier spacing used by the target cell is 960 kHz, the target switching integer being equal to 16.

In one subsidiary embodiment of the above two subembodiments, any of the K1 switching integers is a target switching integer, and the cell corresponding to the target switching integer is a target cell; when the first node receives the physical layer dynamic signaling on at least one symbol outside the first three symbols in the first slot, the subcarrier spacing used by the target cell is 15 kHz, the target switching integer being equal to 2;

the subcarrier spacing used by the target cell is 30 kHz, the target switching integer being equal to 2; the subcarrier spacing used by the target cell is 60 kHz, the target switching integer being equal to 3; the subcarrier spacing used by the target cell is 120 kHz, the target switching integer being equal to 3; the subcarrier spacing used by the target cell is 480 kHz, the target switching integer being equal to 9; the subcarrier spacing used by the target cell is 960 kHz, the target switching integer being equal to 17.

In one embodiment, the first offset value is related to both the subcarrier spacing corresponding to the first cell and the subcarrier spacing corresponding to the cell to which the physical layer dynamic signaling belongs.

In one embodiment, the subcarrier spacing corresponding to the cell to which the physical layer dynamic signaling belongs is a subcarrier spacing of an active DL BWP corresponding to the cell to which the physical layer dynamic signaling belongs at the first time slot.

In one embodiment, the subcarrier spacing corresponding to the first cell is a subcarrier spacing of an active BWP of the first cell.

In one embodiment, the relationship between the subcarrier spacing and the subcarrier spacing parameter in the present application is as follows: the subcarrier spacing is 15 kHz, the subcarrier spacing parameter is 0; the subcarrier spacing is 30 kHz, the subcarrier spacing parameter is 1; the subcarrier spacing is 60 kHz, the subcarrier spacing parameter is 2; the subcarrier spacing is 120 kHz, the subcarrier spacing parameter is 3; the subcarrier spacing is 240 kHz, subcarrier spacing parameter is 4; the subcarrier spacing is 480 kHz, the subcarrier spacing parameter is 5; the subcarrier spacing is 960 kHz, the subcarrier spacing parameter is 6.

In one embodiment, the relationship between the subcarrier spacing and the subcarrier spacing parameter in this application is given in reference to Table 4.2-1 in 3GPP TS 38.211.

### Embodiment 2

Embodiment 2 illustrates a schematic diagram of a network architecture according to one embodiment of the present application, as shown in FIG. 2.

FIG. 2 illustrates a network architecture of Long-Term Evolution (LTE), Long-Term Evolution

Advanced (LTE-A) and future 5G systems. The network architecture of the LTE, LTE-A and future 5G systems may be called an Evolved Packet System (EPS). The 5G NR or LTE network architecture may be referred to as 5G System (5GS)/EPS 200 or some other suitable terminology. The 5GS/EPS 200 may comprise one or more UEs 201, a UE 241 in sidelink communication with the UE(s) 201, an NG-RAN 202, a 5G Core Network/Evolved Packet Core (5G-CN/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane terminations. The gNB 203 can be connected to other gNBs 204 via an Xn interface (like backhaul). The gNB 203 may be called a base station, a base transceiver station, a radio base station, a radio transceiver, a transceiver function, a Basic Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212. The S-GW/UPF 212 itself is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and packet switching (PS) services.

In one embodiment, the first node in the present application includes the UE 201.

In one embodiment, the second node in the present application includes the gNB203.

In one embodiment, the UE 201 includes cellphone.

In one embodiment, the UE 201 is a means of transportation including automobile.

In one embodiment, the gNB 203 is a Macro Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station supporting large time-delay difference.

In one embodiment, the gNB203 is a flight platform.

In one embodiment, the gNB203 is satellite equipment.

In one embodiment, the gNB 203 is a piece of test equipment (e.g., a transceiving device simulating partial functions of the base station, or a signaling test instrument).

In one embodiment, a radio link from the UE 201 to the gNB 203 is an uplink, the uplink being used for performing uplink transmission.

In one embodiment, a radio link from the gNB 203 to the UE 201 is a downlink, the downlink being used for performing downlink transmission.

In one embodiment, a radio link between the UE201 and the gNB203 includes a cellular link.

In one embodiment, the UE 201 and the gNB 203 are connected to each other via a Uu air interface.

In one embodiment, a transmitter of the first DCI includes the gNB 203.

In one embodiment, a receiver of the first DCI includes the UE 201.

In one embodiment, the UE 201 supports the scheduling of Physical Downlink Shared CHannel (PDSCH)/Physical Uplink Shared CHannel (PUSCH) of multiple cells with a single DCI.

### Embodiment 3

Embodiment 3 illustrates a schematic diagram of an example of a radio protocol architecture of a user plane and a control plane according to the present application, as shown in FIG. 3.

FIG. 3 is a schematic diagram illustrating an embodiment of a radio protocol architecture of a user plane 350 and a control plane 300. In FIG. 3, the radio protocol architecture for a control plane 300 between a first communication node (UE, or Road Side Unit/RSU in Vehicle to Everything (V2X), vehicle-mounted equipment or vehicle-mounted communication module) and a second node (gNB, UE, or RSU in V2X, vehicle-mounted equipment or vehicle-mounted communication module), or between two UEs is represented by three layers, i.e., Layer 1 (L1), Layer 2 (L2) and Layer 3 (L3). The L1 is the lowest layer which performs various signal processing functions of PHY (i.e., PHYsical layer). The L1 is called PHY 301 in the present application. The L2 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., Internet Protocol/IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first DCI is generated by the PHY 301 or the PHY 351.

In one embodiment, the higher layer in the present application refers to a layer above the PHY layer.

In one embodiment, the higher layer in the present application comprises a MAC layer.

In one embodiment, the higher layer in the present application comprises an RRC layer.

### Embodiment 4

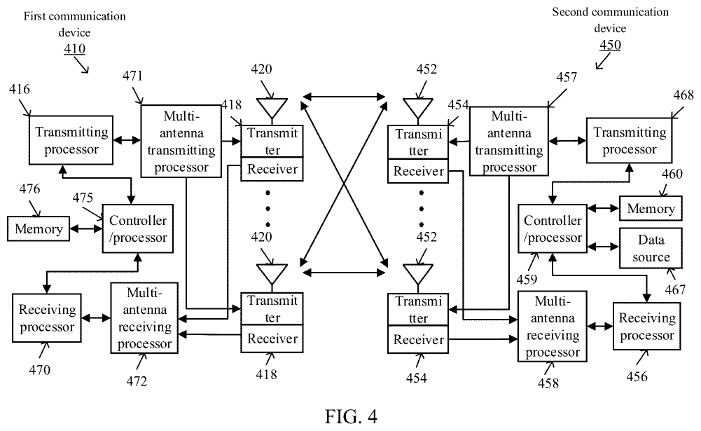

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 and the mapping of signal clusters corresponding to each modulation scheme (i.e., Binary Phase Shift Keying (BPSK), Quadrature Phase Shift Keying (QPSK), M-PSK, and M-Quadrature Amplitude Modulation (M-QAM), etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream to a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna. Each receiver 454 recovers information modulated to the RF carrier, and converts the radio frequency stream into a baseband multicarrier symbol stream to be provided to the receiving processor 456. The receiving processor 456 and the multi-antenna receiving processor 458 provide various signal processing functions of the L1. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using Fast Fourier Transform (FFT). In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2. Or various control signals can be provided to the L3 for processing. The controller/processor 459 also performs error detection using ACKnowledgement (ACK) and/or Negative ACKnowledgement (NACK) protocols as a way to support HARQ operation.

In a transmission from the second communication device 450 to the first communication device 410, at the second communication device 450, the data source 467 is used to provide a higher layer packet to the controller/processor 459. The data source 467 represents all protocol layers above the L2. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including codebook-based precoding and non-codebook-based precoding, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1. The controller/processor 475 provides functions of the L2. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocol to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives a first DCI, the first DCI scheduling K1 cells; at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

In one embodiment, the second communication device 450 comprises a memory that stores a computer readable instruction program. The computer readable instruction program generates actions when executed by at least one processor. The actions include: receiving a first DCI.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits a first DCI, the first DCI scheduling K1 cells; at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

In one embodiment, the first communication device 410 comprises a memory that stores a computer readable instruction program. The computer readable instruction program generates actions when executed by at least one processor. The actions include: transmitting a first DCI.

In one embodiment, the first node in the present application comprises the second communication device 450.

In one embodiment, the second node in the present application comprises the first communication device 410.

In one embodiment, at least one of the antenna 420, the transmitter 418, the transmitting processor 416, the multi-antenna transmitting processor 471, the controller/processor 475 or the memory 476 is used for transmitting the first DCI; at least one of the antenna 452, the receiver 454, the receiving processor 456, the multi-antenna receiving processor 458, the controller/processor 459, the memory 460 or the data source 467 is used for receiving the first DCI.

### Embodiment 5

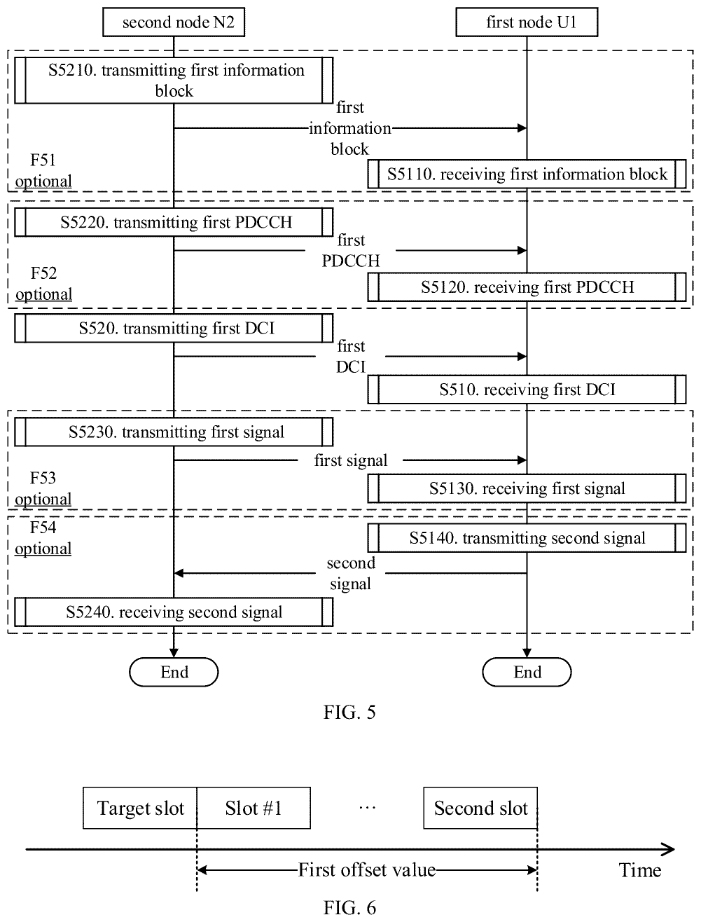

Embodiment 5 illustrates a flowchart of transmission between a first node and a second node according to one embodiment of the present application. In FIG. 5, a first node U1 and a second node N2 are in communication via a radio link, where the steps marked by the box 51, the box F52, the box F53 and the box F54 are optional. It should be particularly noted that the sequence illustrated herein does not set any limit to the signal transmission order or implementation order in the present application.

The first node U1 receives a first information block in step S5110; receives a first PDCCH in step S5120; receives a first DCI in step S510; receives a first signal in step S5130; and transmits a second signal in step S5140.

The second node N2 transmits a first information block in step S5210; transmits a first PDCCH in step S5220; transmits a first DCI in step S520; transmits a first signal in step S5230; and receives a second signal in step S5240.

In Embodiment 5, at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

In one embodiment, the first node U1 is the first node in the present application.

In one embodiment, the second node N2 is the second node in the present application.

In one embodiment, an air interface between the second node N2 and the first node U1 includes a radio interface between a base station and a UE.

In one embodiment, an air interface between the second node N2 and the first node U1 includes a radio interface between a relay node and a UE.

In one embodiment, an air interface between the second node N2 and the first node U1 includes a radio interface between a UE and another UE.

In one embodiment, the second node N2 is a maintenance base station for a serving cell of the first node U1.

In one embodiment, the second node N2 is a maintenance base station for the K1 cells.

In one embodiment, steps in the box F51 in FIG. 5 are present; a method applicable for the first node U1 in this application comprises: receiving a first information block.

In one embodiment, the first information block indicates a first cell set, the first cell set comprising the K1 cells, the cells in the first cell set supporting scheduling by a DCI used to schedule multiple serving cells simultaneously.

In one embodiment, the first information block is carried via a Radio Resource Control (RRC) signaling.

In one embodiment, the first information block is transmitted through an RRC signaling.

In one embodiment, the first information block comprises at least one IE.

In one embodiment, the first information block comprises part or all of fields of each of the at least one IE.

In one embodiment, the first information block is carried via dynamic signaling.

In one embodiment, the first information block is carried via physical layer signaling.

In one embodiment, the first information block is carried via RRC layer signaling and physical layer signaling together.

In one embodiment, the first cell set comprises the K1 cells.

In one embodiment, the first cell set comprises at least one cell other than the K1 cells.

In one embodiment, each cell in the first cell set is a serving cell of the first node U1.

In one embodiment, the first node U1 performs Secondary Cell Addition for each cell in the first cell set.

In one embodiment, a latest sCellToAddModList or sCellToAddModListSCG received by the first node U1 comprises each cell in the first cell set.

In one embodiment, for each cell in the first cell set, the first node U1 is assigned an SCellIndex or ServCellIndex for this cell.

In one embodiment, an RRC connection has been established between the first node U1 and each cell in the first cell set.

In one embodiment, the first cell set includes a SpCell of the first node.

In one embodiment, the first cell set includes an SCell of the first node.

In one embodiment, any cell in the first cell set is a SpCell or SCell of the first node.

In one embodiment, each cell in the first cell set corresponds to a ServCellIndex.

In one embodiment, each cell in the first cell set corresponds to a servCellId.

In one embodiment, each cell in the first cell set corresponds to a scheduledCellId.

In one embodiment, each cell in the first cell set corresponds to a CIF.

In one embodiment, each cell in the first cell set corresponds to a PhysCellId.

In one embodiment, each cell in the first cell set corresponds to a PCI.

In one embodiment, the first information block indicates at least one cell subset, all cells included in the at least one cell subset comprising the first cell set, the first cell subset being one of the at least one cell subset, the first cell subset comprising the K1 cells.

In one subembodiment, a cell supports scheduling by a DCI used to schedule multiple serving cells simultaneously, the cell belonging to the first cell set; a cell does not support scheduling by a DCI used to schedule multiple serving cells simultaneously, the cell not belonging to the first cell set.

In one subembodiment, the first cell subset includes only the K1 cells.

In one subembodiment, the first cell subset comprises at least one cell other than the K1 cells, the at least one cell other than the K1 cells belonging to the first cell set.

In one subembodiment, the first DCI explicitly indicates the first cell subset from the at least one subset.

In one subembodiment, the first information block indicates at least two cell subsets, any two of the at least two cell subsets comprising different cells.

In one embodiment, the first information block indicates at least one cell set, and all cells in the at least one cell set support scheduling by a DCI used to schedule multiple serving cells simultaneously; the first cell set is one of the at least one cell set, the first cell set comprising only the K1 cells.

In one subembodiment, a cell belongs to the first cell set, the cell supporting scheduling by a DCI used to schedule multiple serving cells simultaneously; a cell does not support scheduling by a DCI used to schedule multiple serving cells simultaneously, the cell not belonging to the first cell set.

In one subembodiment, the first information block indicates at least two cell sets, and there exist two cell subsets in the at least two cell sets comprising overlapping cells.

In one subembodiment, the first DCI explicitly or implicitly indicates the first cell set from the at least one cell set.

In one embodiment, the steps in box F51 in FIG. 5 are not present.

In one embodiment, steps in the box F52 in FIG. 5 are present; a method applicable for the first node U1 in this application comprises: receiving a first PDCCH.

In one embodiment, the first PDCCH is transmitted in the first slot, the first PDCCH being the physical layer dynamic signaling used to indicate the first minimum applicable adjustment offset; the first PDCCH is earlier than the first DCI in time domain.

In one embodiment, a DCI carried by the first PDCCH comprises a first field, the first field indicating the first minimum applicable scheduling offset.

In one subembodiment, the first field comprised in the DCI carried by the first PDCCH is a Minimum applicable scheduling offset indicator field.

In one embodiment, the first PDCCH indicates a first candidate minimum applicable scheduling offset and a second candidate minimum applicable scheduling offset, the first candidate minimum applicable scheduling offset being used for an active DL BWP and the second candidate minimum applicable scheduling offset being used for an active UL BWP.

In one subembodiment, the first minimum applicable scheduling offset is equal to the first candidate minimum applicable scheduling offset when the first node U1 is receiving in an active DL BWP.

In one subembodiment, the first minimum applicable scheduling offset is equal to the second candidate minimum applicable scheduling offset when the first node U1 is transmitting in an active UL BWP.

In one subembodiment, the first candidate minimum applicable scheduling offset and the second candidate minimum applicable scheduling offset are K₀ₘᵢₙ and K₂ₘᵢₙ, respectively.

In one embodiment, the steps in box F52 in FIG. 5 are not present.

In one embodiment, steps in the box F53 in FIG. 5 are present; a method applicable for the first node U1 in this application comprises: receiving a first signal.

In one embodiment, the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset.

In one embodiment, the steps in box F53 in FIG. 5 are not present.

In one embodiment, steps in the box F54 in FIG. 5 are present; a method applicable for the first node U1 in this application comprises: transmitting a second signal.

In one embodiment, the second signal comprises K1 second-type sub-signals, the K1 second-type sub-signals being transmitted in the K1 cells, respectively; the first DCI is used to schedule the second signal; a minimum value of a scheduling delay between each of the K1 second-type sub-signals and the first DCI is no smaller than the first minimum applicable scheduling offset.

In one embodiment, the steps marked by the box F54 in FIG. 5 do not exist.

In one embodiment, the steps in box F51 in FIG. 5 are present, the step S5210 being before the step S520 and the step S5110 being before the step S510.

In one embodiment, the steps in box F52 in FIG. 5 are present, the step S5220 being before the step S520 and the step S5120 being before the step S510.

In one embodiment, the steps in box F53 in FIG. 5 are present, the step S5230 being after the step S520 and the step S5130 being after the step S510.

In one subembodiment, the steps marked by the box F54 in FIG. 5 do not exist.

In one embodiment, the steps in box F54 in FIG. 5 are present, the step S5240 being after the step S520 and the step S5140 being after the step S510.

In one subembodiment, the steps marked by the box F53 in FIG. 5 do not exist.

In one embodiment, the steps in both the box F51 and box F52 in FIG. 5 are present, the step S5210 being before the step S5220, and the step S5110 being before the step S5120; the step S5220 is before the step S520, and the step S5120 is before the step S510.

In one embodiment, the box F53 and the box F54 in FIG. 5 cannot co-exist.

In one embodiment, the first information block is transmitted on a downlink physical control channel (i.e., a downlink channel only capable of bearing physical layer signaling).

In one embodiment, a physical layer channel occupied by the first information block includes a PDCCH.

In one embodiment, the first information block is transmitted on a downlink physical data channel (i.e., a downlink channel capable of bearing physical layer data).

In one embodiment, a physical layer channel occupied by the first information block includes a PDSCH.

In one embodiment, the first DCI is transmitted on a downlink physical control channel (i.e., a downlink channel only capable of bearing physical layer signaling).

In one embodiment, a physical layer channel occupied by the first DCI includes a Physical Downlink Control CHannel (PDCCH).

In one embodiment, the first signal is transmitted on a downlink physical data channel (i.e., a downlink channel capable of bearing physical layer data).

In one embodiment, a physical layer channel occupied by the first signal includes a PDSCH.

In one embodiment, a transport channel occupied by the first signal includes a Downlink-Shared CHannel (DL-SCH).

In one embodiment, the second signal is transmitted on an uplink physical data channel (i.e. an uplink channel capable of bearing physical layer data).

In one embodiment, a physical layer channel occupied by the second signal includes a PUSCH.

In one embodiment, a transport channel occupied by the second signal includes an UpLink-Shared CHannel (UL-SCH).

### Embodiment 6

Embodiment 6 illustrates a schematic diagram of a relation between a second slot and a target slot according to one embodiment of the present application, as shown in FIG. 6. In FIG. 6, the horizontal axis represents time; a rectangle represents a slot in time; the second slot is delayed by the first offset value compared to the target slot.

In Embodiment 6, a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one embodiment, the second slot is delayed by the first offset value compared to a target slot; and a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one embodiment, a slot index corresponding to the first slot is a slot index calculated in accordance with a subcarrier spacing employed by a cell to which the physical layer dynamic signaling belongs.

In one embodiment, a subcarrier spacing parameter of a subcarrier spacing employed by the cell to which the physical layer dynamic signaling belongs is a subcarrier spacing parameter of a subcarrier spacing of an active DL BWP corresponding to the cell to which the physical layer dynamic signaling belongs at the first slot.

In one embodiment, a subcarrier spacing parameter of a subcarrier spacing employed by the cell to which the physical layer dynamic signaling belongs is a subcarrier spacing parameter of a subcarrier spacing employed by the physical layer dynamic signaling.

In one embodiment, the first ratio is equal to

$$\frac{{2}^{μ} PDSCH}{{2}^{μ} PDCCH} ,$$

where μ_{PDSCH} is the first parameter and μ_{PDCCH} is the second parameter.

In one embodiment, the first value is equal to

$$n \cdot \frac{{2}^{μ} PDSCH}{{2}^{μ} PDCCH} ,$$

where n corresponds to a corresponding slot index of the first slot in a cell in which the first DCI is located, μ_{PDSCH} is the first parameter, and μ_{PDCCH} is the second parameter.

In one embodiment, a slot index corresponding to the target slot is equal to

$$⌊ n \cdot \frac{{2}^{μ} PDSCH}{{2}^{μ} PDCCH} ⌋ ,$$

where n corresponds to a slot index corresponding to the first slot in a cell in which the first DCI is located, μ_{PDSCH} is the first parameter, and μ_{PDCCH} is the second parameter.

In one embodiment, the first offset value is equal to a greater value between the currently applicable K₀ₘᵢₙ and a first integer, the first integer being dependent on the subcarrier spacing corresponding to the first cell and the position of a symbol occupied by the physical layer dynamic signaling in the first slot.

In one subembodiment, the currently applicable K₀ₘᵢₙ is a currently applicable K₀ₘᵢₙ of the first cell.

In one subembodiment, the currently applicable K₀ₘᵢₙ is a K₀ₘᵢₙ indicated by a DCI prior to the physical layer dynamic signaling.

In one subembodiment, the currently applicable K₀ₘᵢₙ is a K₀ₘᵢₙ indicated by and in effect for a DCI prior to the physical layer dynamic signaling.

In one subembodiment, the currently applicable K₀ₘᵢₙ is a K₀ₘᵢₙ of the first cell as indicated by a DCI prior to the physical layer dynamic signaling.

In one subembodiment, the currently applicable K₀ₘᵢₙ is a K₀ₘᵢₙ of the first cell as indicated by and in effect for a DCI prior to the physical layer dynamic signaling.

In one subembodiment, the first node receives the physical layer dynamic signaling on at least one symbol within the first three symbols in the first slot.

In one subsidiary embodiment of the above subembodiment, the subcarrier spacing corresponding to the first cell is 15 kHz, the first integer being equal to 1; the subcarrier spacing corresponding to the first cell is 30 kHz, the first integer being equal to 1; the subcarrier spacing corresponding to the first cell is 60 kHz, the first integer being equal to 2; the subcarrier spacing corresponding to the first cell is 120 kHz, the first integer being equal to 2; the subcarrier spacing corresponding to the first cell is 480 kHz, the first integer being equal to 8; the subcarrier spacing corresponding to the first cell is 960 kHz, the first integer being equal to 16.

In one subembodiment, the first node receives the physical layer dynamic signaling on at least one symbol outside the first three symbols in the first slot.

In one subsidiary embodiment of the above subembodiment, the subcarrier spacing corresponding to the first cell is 15 kHz, the first integer being equal to 2; the subcarrier spacing corresponding to the first cell is 30 kHz, the first integer being equal to 2; the subcarrier spacing corresponding to the first cell is 60 kHz, the first integer being equal to 3; the subcarrier spacing corresponding to the first cell is 120 kHz, the first integer being equal to 3; the subcarrier spacing corresponding to the first cell is 480 kHz, the first integer being equal to 9; the subcarrier spacing corresponding to the first cell is 960 kHz, the first integer being equal to 17.

In one subembodiment, the correspondence between the first integer and the subcarrier spacing corresponding to the first cell is shown in Table 5.3.1-1 of 3GPP TS 38.214.

In one embodiment, the first offset value is equal to a greater value between the currently applicable K₀ₘᵢₙ and a second value, the second value being a largest integer not greater than a second integer multiplied by the first ratio, the second integer being dependent on the subcarrier spacing employed by the cell to which the physical layer dynamic signaling belongs and the position of the symbol occupied by the physical layer dynamic signaling in the first slot.

In one subembodiment, the currently applicable K₀ₘᵢₙ is a currently applicable K₀ₘᵢₙ of the first cell.

In one subembodiment, the currently applicable K₀ₘᵢₙ is a K₀ₘᵢₙ indicated by a DCI prior to the physical layer dynamic signaling.

In one subembodiment, the currently applicable K₀ₘᵢₙ is a K₀ₘᵢₙ indicated by and in effect for a DCI prior to the physical layer dynamic signaling.

In one subembodiment, the currently applicable K₀ₘᵢₙ is a K₀ₘᵢₙ of the first cell as indicated by a DCI prior to the physical layer dynamic signaling.

In one subembodiment, the currently applicable K₀ₘᵢₙ is a K₀ₘᵢₙ of the first cell as indicated by and in effect for a DCI prior to the physical layer dynamic signaling.

In one subembodiment, the first node receives the physical layer dynamic signaling on at least one symbol within the first three symbols in the first slot.

In one subsidiary embodiment of the above subembodiment, the subcarrier spacing used by the cell to which the physical layer dynamic signaling belongs is 15 kHz, the second integer being equal to 1; the subcarrier spacing used by the cell to which the physical layer dynamic signaling belongs is 30 kHz, the second integer being equal to 1; the subcarrier spacing used by the cell to which the physical layer dynamic signaling belongs is 60 kHz, the second integer being equal to 2; the subcarrier spacing used by the cell to which the physical layer dynamic signaling belongs is 120 kHz, the second integer being equal to 2; the subcarrier spacing used by the cell to which the physical layer dynamic signaling belongs is 480 kHz, the second integer being equal to 8; the subcarrier spacing used by the cell to which the physical layer dynamic signaling belongs is 960 kHz, the second integer being equal to 16.

In one subembodiment, the first node receives the physical layer dynamic signaling on at least one symbol outside the first three symbols in the first slot.

In one subsidiary embodiment of the above subembodiment, the subcarrier spacing used by the cell to which the physical layer dynamic signaling belongs is 15 kHz, the second integer being equal to 2; the subcarrier spacing used by the cell to which the physical layer dynamic signaling belongs is 30 kHz, the second integer being equal to 2; the subcarrier spacing used by the cell to which the physical layer dynamic signaling belongs is 60 kHz, the second integer being equal to 3; the subcarrier spacing used by the cell to which the physical layer dynamic signaling belongs is 120 kHz, the second integer being equal to 3; the subcarrier spacing used by the cell to which the physical layer dynamic signaling belongs is 480 kHz, the second integer being equal to 9; the subcarrier spacing used by the cell to which the physical layer dynamic signaling belongs is 960 kHz, the second integer being equal to 17.

In one subembodiment, the correspondence between the second integer and the subcarrier spacing used by the cell to which the physical layer dynamic signaling belongs is given in Table 5.3.1-1 of TS 38.214.

In one embodiment, “the second slot is delayed by the first offset value compared to the target slot” means that an index of the second slot is an index of the target slot plus the first offset value.

In one embodiment, “the second slot is delayed by the first offset value compared to the target slot” means that the second slot is the X-th slot after the target slot where X is the first offset value.

In one embodiment, “the second slot is delayed by the first offset value compared to the target slot” means that there are (first offset value−1) consecutive slots between the second slot and the target slot, where the (first offset value−1) consecutive slots do not include the target slot or the second slot.

### Embodiment 7

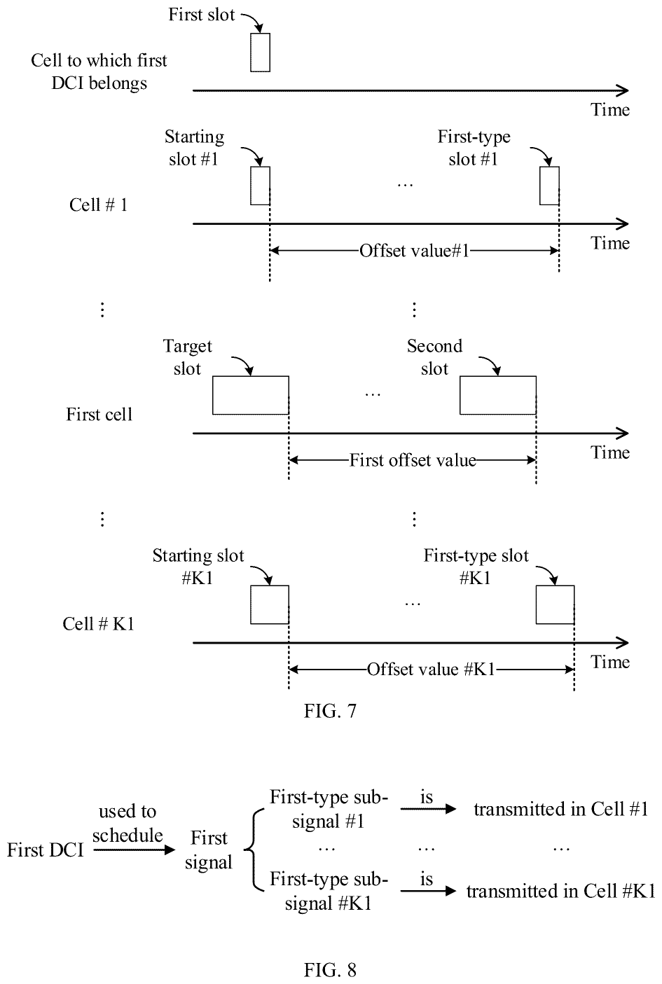

Embodiment 7 illustrates a schematic diagram of a relation between K1 first-type slots and a first slot according to one embodiment of the present application, as shown in FIG. 7. In FIG. 7, the horizontal axis represents time; the K1 first-type slots are represented as a first-type slot #1 . . . , a second slot, . . . , a first-type slot #K1, and the second slot in the present application is one of the K1 first-type slots; the K1 offset values are represented as an offset value #1, . . . , a first offset value, . . . , an offset value #K1, and the first offset value is one of the K1 offset values.

In Embodiment 7, a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

In one embodiment, a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

In one embodiment, “a minimum value of a scheduling delay between a channel scheduled by the first DCI and the first DCI in at least one cell among the K1 cells depends on a first minimum applicable scheduling offset” means that the first node will not expect a scheduling delay between a channel scheduled by the first DCI in any of the K1 cells and the first DCI to be smaller than the first minimum applicable scheduling offset. In one embodiment, “a minimum value of a scheduling delay between a channel scheduled by the first DCI and the first DCI in at least one cell among the K1 cells depends on a first minimum applicable scheduling offset” means that the first node assumes a scheduling delay between a channel scheduled by the first DCI in each of the K1 cells and the first DCI to be not smaller than the first minimum applicable scheduling offset.

In one embodiment, the K1 first-type slots are K1 slots, respectively.

In one embodiment, the K1 first-type slots are K1 uplink slots, respectively.

In one embodiment, the K1 first-type slots are K1 downlink slots, respectively.

In one embodiment, the K1 first-type slots are K1 flexible slots, respectively.

In one embodiment, the K1 first-type slots occupy time-domain resources of the K1 cells, respectively.

In one embodiment, the K1 first-type slots occupy time-domain resources configured by the K1 cells, respectively.

In one embodiment, the K1 first-type slots occupy time-domain resources corresponding to the K1 cells, respectively.

In one embodiment, the K1 first-type slots belong to time-domain resources of the K1 cells, respectively.

In one embodiment, the K1 first-type slots belong to time-domain resources configured by the K1 cells, respectively.

In one embodiment, the K1 first-type slots belong to time-domain resources corresponding to the K1 cells, respectively.

In one embodiment, the second slot is a first-type slot among the K1 first-type slots.

In one embodiment, the second slot is a slot occupying time-domain resources of the first cell among the K1 first-type slots.

In one embodiment, the second slot is a slot occupying time-domain resources configured by the first cell among the K1 first-type slots.

In one embodiment, the second slot is a slot occupying time-domain resources corresponding to the first cell among the K1 first-type slots.

In one embodiment, the second slot is a slot belonging to time-domain resources configured by the first cell among the K1 first-type slots.

In one embodiment, the second slot is a slot belonging to time-domain resources of the first cell among the K1 first-type slots.

In one embodiment, the second slot is a slot belonging to time-domain resources corresponding to the first cell among the K1 first-type slots.

In one embodiment, “the first minimum applicable scheduling offset is applicable for K1 first-type slots in the K1 cells” means that the first minimum applicable scheduling offset is effective in the K1 cells from the K1 first-type slots in the K1 cells respectively.

In one embodiment, “the first minimum applicable scheduling offset is applicable for K1 first-type slots in the K1 cells” means that the first minimum applicable scheduling offset is effective for schedulings in the K1 cells from the K1 first-type slots in the K1 cells respectively.

In one embodiment, each of the K1 first-type slots is dependent on the first slot.

In one embodiment, the K1 first-type slots correspond to K1 starting slots, the K1 first-type slots are each dependent on one of the K1 starting slots, and the K1 slots are all dependent on the first slot.

In one subembodiment, the target slot in this application is one of the K1 starting slots.

In one subembodiment, the target slot in this application is a slot among the K1 starting slots that occupies time-domain resource of the first cell.

In one subembodiment, the target slot in this application is a slot among the K1 starting slots that occupies time-domain resource corresponding to the first cell.

In one subembodiment, the target slot in this application is a slot among the K1 starting slots that occupies time-domain resource configured by the first cell.

In one subembodiment, the target slot in this application is a slot among the K1 starting slots that belongs to time-domain resource of the first cell.

In one subembodiment, the target slot in this application is a slot among the K1 starting slots that belongs to time-domain resource corresponding to the first cell.

In one subembodiment, the target slot in this application is a slot among the K1 starting slots that belongs to time-domain resource configured by the first cell.

In one embodiment, the K1 first-type slots respectively correspond to the K1 offset values; the K1 first-type slots are each dependent on one of the K1 offset values.

In one subembodiment, the first offset value is an offset value of the K1 offset values.

In one subembodiment, the first offset value is an offset value of the K1 offset values that is dependent on the first cell.

In one subembodiment, the first offset value is an offset value of the K1 offset values that is related to a subcarrier spacing corresponding to the first cell.

In one embodiment, the K1 first-type slots are respectively delayed by the K1 offset values compared to the K1 starting slots; any starting slot of the K1 starting slots is a given slot; the given slot is indexed by a maximum integer not greater than a given value, the given value being equal to the product obtained by multiplying the slot index corresponding to the first slot by the given ratio; the given ratio is equal to the quotient obtained by dividing a power of a given parameter of 2 by a power of a second parameter of 2, the given parameter is a subcarrier spacing parameter corresponding to the cell to which the given slot belongs, and the second parameter is equal to a subcarrier spacing parameter of a subcarrier spacing used by the physical layer dynamic signaling.

In one subembodiment, the given ratio is equal to

$$\frac{{2}^{μ} PDSCH , c}{{2}^{μ} PDCCH} ,$$

where c denotes the cell to which the given slot belongs, μ_{PDSCH,c} is the subcarrier spacing parameter corresponding to the cell to which the given slot belongs, and μ_{PDCCH} is the second parameter.

In one subembodiment, the given value is equal to

$$n \cdot \frac{{2}^{μ} PDSCH , c}{{2}^{μ} PDCCH} ,$$

where n corresponds to the slot index corresponding to the first slot in the cell to which the physical layer dynamic signaling belongs, c denotes the cell to which the given slot belongs, μ_{PDSCH,c} is the subcarrier spacing parameter corresponding to the cell to which the given slot belongs, and μ_{PDCCH} is the second parameter.

In one subembodiment, the slot index corresponding to the given slot is equal to

$$⌊ n \cdot \frac{{2}^{μ} PDSCH , c}{{2}^{μ} PDCCH} ⌋ ,$$

where n corresponds to the slot index corresponding to the first slot in the cell to which the physical layer dynamic signaling belongs, c denotes the cell to which the given slot belongs, μ_{PDSCH,c} is a subcarrier spacing parameter corresponding to the cell to which the given slot belongs, and μ_{PDCCH} is the second parameter.

In one subembodiment, the given slot occupies the time-domain resources of a given cell among the K1 cells, a given offset value is one of the K1 offset values, and the given offset value is applied to the given cell, a minimum value of scheduling delay between a channel scheduled by the first DCI in the given cell and the first DCI depends on the first minimum applicable scheduling offset, the first minimum applicable scheduling offset being applicable for a given first-type slot in the given cell, the given first-type slot being delayed by the given offset value compared to the given slot.

In one subsidiary embodiment of the above subembodiment, the given offset value is equal to a greater value of the currently applicable K₀ₘᵢₙ and a given integer, the given integer being dependent on the subcarrier spacing corresponding to the given cell.

In one subsidiary embodiment of the above subsidiary embodiment, the currently applicable K₀ₘᵢₙ is a currently applicable K₀ₘᵢₙ of the given cell.

In one subsidiary embodiment of the above subsidiary embodiment, the currently applicable K₀ₘᵢₙ is a K₀ₘᵢₙ indicated by a DCI prior to the physical layer dynamic signaling.

In one subsidiary embodiment of the above subsidiary embodiment, the currently applicable K₀ₘᵢₙ is a K₀ₘᵢₙ indicated by and in effect for a DCI prior to the physical layer dynamic signaling.

In one subsidiary embodiment of the above subsidiary embodiment, the currently applicable K₀ₘᵢₙ is a K₀ₘᵢₙ of the given cell indicated by a DCI prior to the physical layer dynamic signaling.

In one subsidiary embodiment of the above subsidiary embodiment, the currently applicable K₀ₘᵢₙ is a K₀ₘᵢₙ of the given cell indicated by and in effect for a DCI prior to the physical layer dynamic signaling.

In one subsidiary embodiment of the above subsidiary embodiment, when the first node receives the physical layer dynamic signaling on at least one symbol within the first three symbols in the first slot, the subcarrier spacing corresponding to the given cell is 15 kHz and the given integer is equal to 1; the subcarrier spacing corresponding to the given cell is 30 kHz and the given integer is equal to 1; the subcarrier spacing corresponding to the given cell is 60kHz and the given integer is equal to 2; the subcarrier spacing corresponding to the given cell is 120 kHz and the given integer is equal to 2; the subcarrier spacing corresponding to the given cell is 480 kHz and the given integer is equal to 8; the subcarrier spacing corresponding to the given cell is 960 kHz and the given integer is equal to 16.

In one subsidiary embodiment of the above subsidiary embodiment, when the first node receives the physical layer dynamic signaling on at least one symbol outside the first three symbols in the first slot, the subcarrier spacing corresponding to the given cell is 15 kHz and the given integer is equal to 2; the subcarrier spacing corresponding to the given cell is 30 kHz and the given integer is equal to 2; the subcarrier spacing corresponding to the given cell is 60 kHz and the given integer is equal to 3; the subcarrier spacing corresponding to the given cell is 120 KHz and the given integer is equal to 3; the subcarrier spacing corresponding to the given cell is 480 kHz and the given integer is equal to 9; the subcarrier spacing corresponding to the given cell is 960 kHz and the given integer is equal to 17.

In one subsidiary embodiment of the above subsidiary embodiment, the correspondence between the given integer and the subcarrier spacing corresponding to the given cell is shown in Table 5.3.1-1 of 3GPP TS 38.214.

In one subsidiary embodiment of the above subembodiment, the first offset value is equal to a greater value of the currently applicable K₀ₘᵢₙ and a given integer, the given integer being the largest integer not greater than a target switching integer multiplied by the given ratio, the target switching integer being dependent on the subcarrier spacing employed by the cell to which the physical layer dynamic signaling belongs.

In one subsidiary embodiment of the above subsidiary embodiment, the currently applicable K₀ₘᵢₙ is a currently applicable K₀ₘᵢₙ of the given cell.

In one subsidiary embodiment of the above subsidiary embodiment, the currently applicable K₀ₘᵢₙ is a K₀ₘᵢₙ indicated by a DCI prior to the physical layer dynamic signaling.

In one subsidiary embodiment of the above subsidiary embodiment, the currently applicable K₀ₘᵢₙ is a K₀ₘᵢₙ indicated by and in effect for a DCI prior to the physical layer dynamic signaling.

In one subsidiary embodiment of the above subsidiary embodiment, the currently applicable K₀ₘᵢₙ is a K₀ₘᵢₙ of the given cell indicated by a DCI prior to the physical layer dynamic signaling.

In one subsidiary embodiment of the above subsidiary embodiment, the currently applicable K₀ₘᵢₙ is a K₀ₘᵢₙ of the given cell indicated by and in effect for a DCI prior to the physical layer dynamic signaling.

In one subsidiary embodiment of the above subsidiary embodiment, when the first node receives the physical layer dynamic signaling on at least one symbol within the first three symbols in the first slot, the subcarrier spacing used by the cell to which the physical layer dynamic signaling belongs is 15 kHz, the target integer being equal to 1; the subcarrier spacing used by the cell to which the physical layer dynamic signaling belongs is 30 kHz, the target integer being equal to 1; the subcarrier spacing used by the cell to which the physical layer dynamic signaling belongs is 60 kHz, the target integer being equal to 2; the subcarrier spacing used by the cell to which the physical layer dynamic signaling belongs is 120 kHz, the target integer being equal to 2; the subcarrier spacing used by the cell to which the physical layer dynamic signaling belongs is 480 kHz, the target integer being equal to 8; the subcarrier spacing used by the cell to which the physical layer dynamic signaling belongs is 960 kHz, the target integer being equal to 16.

In one subsidiary embodiment of the above subsidiary embodiment, when the first node receives the physical layer dynamic signaling on at least one symbol outside the first three symbols in the first slot, the subcarrier spacing used by the cell to which the physical layer dynamic signaling belongs is 15 kHz, the target integer being equal to 2; the subcarrier spacing used by the cell to which the physical layer dynamic signaling belongs is 30 kHz, the target integer being equal to 2; the subcarrier spacing used by the cell to which the physical layer dynamic signaling belongs is 60 kHz, the target integer being equal to 3; the subcarrier spacing used by the cell to which the physical layer dynamic signaling belongs is 120 kHz, the target integer being equal to 3; the subcarrier spacing used by the cell to which the physical layer dynamic signaling belongs is 480 kHz, the target integer being equal to 9; the subcarrier spacing used by the cell to which the physical layer dynamic signaling belongs is 960 kHz, the target integer being equal to 17.

In one subsidiary embodiment of the above subsidiary embodiment, the correspondence between the target integer and the subcarrier spacing used by the cell to which the physical layer dynamic signaling belongs is shown in Table 5.3.1-1 of TS 38.214.

In one embodiment, K1 subcarrier spacings corresponding to the K1 cells are subcarrier spacings of K1 active BWPs on the K1 cells, respectively.

### Embodiment 8

Embodiment 8 illustrates a schematic diagram of a first signal according to one embodiment of the present application, as shown in FIG. 8. In FIG. 8, the first signal comprises K1 first-type sub-signals, the K1 first-type sub-signals being transmitted in the K1 cells, respectively; the first DCI is used to schedule the first signal

In Embodiment 8, a minimum value of a scheduling delay between each of the K1 first-type sub-signals and the first DCI is no smaller than the first minimum applicable scheduling offset.

In one embodiment, the first signal comprises a baseband signal.

In one embodiment, the first signal comprises a radio frequency signal.

In one embodiment, the first signal comprises a radio signal.

In one embodiment, the first signal corresponds to a Downlink (DL) assignment.

In one embodiment, the first signal is a PDSCH transmission based on dynamic scheduling.

In one embodiment, the first signal is generated by at least one bit block.

In one embodiment, the first signal is generated by at least one Transport Block (TB).

In one embodiment, the first signal comprises K1 first-type sub-signals, the K1 first-type sub-signals being transmitted in the K1 cells, respectively.

In one subembodiment, K1 physical layer channels occupied by the K1 first-type sub-signals are K1 PDSCHs, respectively.

In one subembodiment, K1 transmission channels occupied by the K1 first-type sub-signals are K1 DL-SCHs, respectively.

In one subembodiment, any of the K1 first-type sub-signals is generated by at least one bit block.

In one subembodiment, any of the K1 first-type sub-signals is generated by at least one TB.

In one subembodiment, the K1 first-type sub-signals each correspond to a different TB.

In one subembodiment, the K1 first-type sub-signals correspond to K1 Hybrid Automatic Repeat reQuest-ACKnowledgements (HARQ-ACKs) respectively.

In one subembodiment, the K1 first-type sub-signals correspond to a same HARQ-ACK.

In one embodiment, the first DCI is a downlink scheduling DCI.

In one embodiment, the first DCI is not used for uplink scheduling.

In one embodiment, the first DCI is used to schedule the second signal.

In one embodiment, the first DCI indicates the frequency-domain resources occupied by the second signal.

In one embodiment, the first DCI indicates the time-domain resources occupied by the second signal.

In one embodiment, the first minimum applicable scheduling offset is K₀ₘᵢₙ.

### Embodiment 9

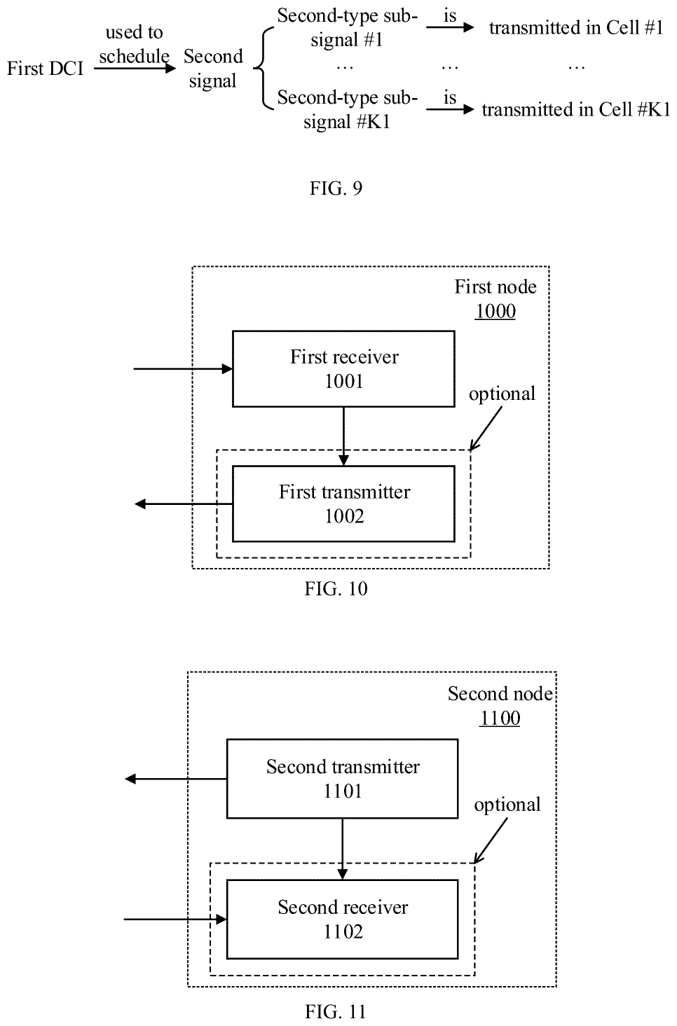

Embodiment 9 illustrates a schematic diagram of a second signal according to one embodiment of the present application, as shown in FIG. 9. In FIG. 9, the second signal comprises K1 second-type sub-signals, the K1 second-type sub-signals being transmitted in the K1 cells, respectively; the first DCI is used to schedule the second signal.

In Embodiment 9, a minimum value of a scheduling delay between each of the K1 second-type sub-signals and the first DCI is no smaller than the first minimum applicable scheduling offset.

In one embodiment, the second signal comprises a baseband signal.

In one embodiment, the second signal comprises a radio frequency signal.

In one embodiment, the second signal comprises a radio signal.

In one embodiment, the second signal corresponds to a Downlink (DL) assignment.

In one embodiment, the second signal is a PDSCH transmission based on dynamic scheduling.

In one embodiment, the second signal is generated by at least one bit block.

In one embodiment, the second signal is generated by at least one TB.

In one embodiment, the second signal comprises Uplink Control Information (UCI).

In one embodiment, the second signal comprises a HARQ-ACK.

In one embodiment, the second signal corresponds to an Uplink (UL) Grant.

In one embodiment, the second signal is a PUSCH transmission based on dynamic scheduling.

In one embodiment, the second signal comprises K1 second-type sub-signals, the K1 second-type sub-signals being transmitted in the K1 cells, respectively.

In one subembodiment, K1 physical layer channels occupied by the K1 second-type sub-signals are K1 PUSCHs, respectively.

In one subembodiment, K1 transmission channels occupied by the K1 second-type sub-signals are K1 UL-SCHs, respectively.

In one subembodiment, any of the K1 second-type sub-signals is generated by at least one bit block.

In one subembodiment, any of the K1 second-type sub-signals is generated by at least one TB.

In one subembodiment, the K1 second-type sub-signals each correspond to a different TB.

In one embodiment, the first DCI is an uplink scheduling DCI.

In one embodiment, the first DCI is not used for downlink scheduling.

In one embodiment, the first DCI is used to schedule the second signal.

In one embodiment, the first DCI indicates the frequency-domain resources occupied by the second signal.

In one embodiment, the first DCI indicates the time-domain resources occupied by the second signal.

In one embodiment, the first minimum applicable scheduling offset is K₂ₘᵢₙ.

### Embodiment 10

Embodiment 10 illustrates a structure block diagram of a processing device used in a first node according to one embodiment of the present application, as shown in FIG. 10. In FIG. 10, a processing device 1000 in a first node comprises a first receiver 1001 and a first transmitter 1002, where the first transmitter 1002 is optional.

In Embodiment 10, the first receiver 1001 receives a first DCI, the first DCI scheduling K1 cells.

In Embodiment 10, at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

In one embodiment, the second slot is delayed by the first offset value compared to a target slot, and a

slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one embodiment, a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

In one embodiment, the first receiver 1001 receives a first PDCCH; the first PDCCH is transmitted in the first slot, the first PDCCH being the physical layer dynamic signaling used to indicate the first minimum applicable adjustment offset; the first PDCCH is earlier than the first DCI in time domain.

In one embodiment, the first receiver 1001 receives a first signal; the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset.

In one embodiment, the first transmitter 1002 transmits a second signal; the second signal comprises K1 second-type sub-signals, the K1 second-type sub-signals being transmitted in the K1 cells, respectively; the first DCI is used to schedule the second signal; a minimum value of a scheduling delay between each of the K1 second-type sub-signals and the first DCI is no smaller than the first minimum applicable scheduling offset.

In one embodiment, the first receiver 1001 receives a first information block; the first information block indicates a first cell set, the first cell set comprising the K1 cells, the cells in the first cell set supporting scheduling by a DCI used to schedule multiple serving cells simultaneously.

In one embodiment, a third slot is delayed by the first offset value compared to the first slot, and a slot index corresponding to the second slot is a maximum integer no greater than a third value, the third value being equal to a product of the slot index corresponding to the third slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one embodiment, the first offset value is equal to a greater value between the currently applicable K₀ₘᵢₙ and a first integer, the first integer being dependent on the subcarrier spacing corresponding to the first cell and the position of a symbol occupied by the physical layer dynamic signaling in the first slot.

In one embodiment, the first offset value is equal to a greater value between the currently applicable K₀ₘᵢₙ and a second value, the second value being a largest integer not greater than a second integer multiplied by the first ratio, the second integer being dependent on the subcarrier spacing employed by the cell to which the physical layer dynamic signaling belongs and the position of the symbol occupied by the physical layer dynamic signaling in the first slot.

In one embodiment, the first receiver 1001 receives.

In one embodiment, the first node is a UE.

In one embodiment, the first node is a relay node.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

### Embodiment 11

Embodiment 11 illustrates a structure block diagram of a processing device used in a second node according to one embodiment of the present application, as shown in FIG. 11. In FIG. 11, a processing device 1100 in a second node comprises a second transmitter 1101 and a second receiver 1102, where the second receiver 1102 is optional.

In Embodiment 11, the second transmitter 1101 transmits a first DCI, the first DCI scheduling K1 cells.

In Embodiment 11, at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell starting from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

In one embodiment, the second slot is delayed by the first offset value compared to a target slot, and a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one embodiment, a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

In one embodiment, the second transmitter 1101 transmits a first PDCCH; the first PDCCH is transmitted in the first slot, the first PDCCH being the physical layer dynamic signaling used to indicate the first minimum applicable adjustment offset; the first PDCCH is earlier than the first DCI in time domain.

In one embodiment, the second transmitter 1101 transmits a first signal; the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset.

In one embodiment, the second receiver 1102 receives a second signal; the second signal comprises K1 second-type sub-signals, the K1 second-type sub-signals being transmitted in the K1 cells, respectively; the first DCI is used to schedule the second signal; a minimum value of a scheduling delay between each of the K1 second-type sub-signals and the first DCI is no smaller than the first minimum applicable scheduling offset.

In one embodiment, the second transmitter 1101 transmits a first information block; the first information block indicates a first cell set, the first cell set comprising the K1 cells, the cells in the first cell set supporting scheduling by a DCI used to schedule multiple serving cells simultaneously.

In one embodiment, a third slot is delayed by the first offset value compared to the first slot, and a slot index corresponding to the second slot is a maximum integer no greater than a third value, the third value being equal to a product of the slot index corresponding to the third slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

In one embodiment, the first offset value is equal to a greater value between the currently applicable K₀ₘᵢₙ and a first integer, the first integer being dependent on the subcarrier spacing corresponding to the first cell and the position of a symbol occupied by the physical layer dynamic signaling in the first slot.

In one embodiment, the first offset value is equal to a greater value between the currently applicable K₀ₘᵢₙ and a second value, the second value being a largest integer not greater than a second integer multiplied by the first ratio, the second integer being dependent on the subcarrier spacing employed by the cell to which the physical layer dynamic signaling belongs and the position of the symbol occupied by the physical layer dynamic signaling in the first slot.

In one embodiment, the second node is a base station.

In one embodiment, the second node is a UE.

In one embodiment, the second node is a relay node.

In one embodiment, the second transmitter 1101 comprises at least one of the antenna 420, the transmitter 418, the transmitting processor 416, the multi-antenna transmitting processor 471, the controller/processor 475 or the memory 476 in Embodiment 4.

In one embodiment, the second receiver 1102 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly; each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles, RSU, wireless sensor, network cards, terminals for Internet of Things (IOT), Radio Frequency Identification (RFID) terminals, Narrow Band Internet of Things (NB-IOT) terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, evolved Node B/eNB, gNB, Transmitter Receiver Point (TRP), Global Navigation Satellite System (GNSS), relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first DCI, the first DCI scheduling K1 cells;
wherein at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

2. The first node according to claim 1, characterized in that the second slot is delayed by the first offset value compared to a target slot, and a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

3. The first node according to claim 1, characterized in that a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

4. The first node according to claim 1, characterized in comprising:
the first receiver, receiving a first PDCCH;
wherein the first PDCCH is transmitted in the first slot, the first PDCCH being the physical layer dynamic signaling used to indicate the first minimum applicable adjustment offset; the first PDCCH is earlier than the first DCI in time domain.

5. The first node according to claim 1, characterized in comprising:
the first receiver, receiving a first signal;
wherein the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset.

6. The first node according to claim 1, characterized in comprising:
a first transmitter, transmitting a second signal;
wherein the second signal comprises K1 second-type sub-signals, the K1 second-type sub-signals being transmitted in the K1 cells, respectively; the first DCI is used to schedule the second signal; a minimum value of a scheduling delay between each of the K1 second-type sub-signals and the first DCI is no smaller than the first minimum applicable scheduling offset.

7. The first node according to claim 1, characterized in comprising:
the first receiver, receiving a first information block;
wherein the first information block indicates a first cell set, the first cell set comprising the K1 cells, the cells in the first cell set supporting scheduling by a DCI used to schedule multiple serving cells simultaneously.

8. A second node for wireless communications, comprising:
a second transmitter, transmitting a first DCI, the first DCI scheduling K1 cells;
wherein at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

9. The second node according to claim 8, characterized in that the second slot is delayed by the first offset value compared to a target slot, and a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

10. The second node according to claim 8, characterized in that a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

11. The second node according to claim 8, characterized in comprising:
the second transmitter, transmitting a first PDCCH;
wherein the first PDCCH is transmitted in the first slot, the first PDCCH being the physical layer dynamic signaling used to indicate the first minimum applicable adjustment offset; the first PDCCH is earlier than the first DCI in time domain.

12. The second node according to claim 8, characterized in comprising:
the second transmitter, transmitting a first signal;
wherein the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset.

13. The second node according to claim 8, characterized in comprising:
a second receiver, receiving a second signal;
wherein the second signal comprises K1 second-type sub-signals, the K1 second-type sub-signals being transmitted in the K1 cells, respectively; the first DCI is used to schedule the second signal; a minimum value of a scheduling delay between each of the K1 second-type sub-signals and the first DCI is no smaller than the first minimum applicable scheduling offset.

14. The second node according to claim 8, characterized in comprising:
the second transmitter, transmitting a first information block;
wherein the first information block indicates a first cell set, the first cell set comprising the K1 cells, the cells in the first cell set supporting scheduling by a DCI used to schedule multiple serving cells simultaneously.

15. A method in a first node for wireless communications, comprising:
receiving a first DCI, the first DCI scheduling K1 cells;
wherein at least 2 cells among the K1 cells respectively correspond to subcarrier spacings that are unequal, K1 being a positive integer greater than 1; a minimum value of a scheduling delay between a channel scheduled by the first DCI and the first DCI in at least one cell among the K1 cells depends on a first minimum applicable scheduling offset; the first minimum applicable scheduling offset is indicated via a physical layer dynamic signaling in a first slot; a first cell is one of the K1 cells, and the first cell is different from a cell to which the physical layer dynamic signaling belongs, the first minimum applicable scheduling offset applying to the first cell from a second slot of the first cell; the second slot depends on the first slot and a first offset value, the first offset value being related to both a subcarrier spacing corresponding to the first cell and a subcarrier spacing corresponding to the cell to which the physical layer dynamic signaling belongs.

16. The method in the first node according to claim 15, characterized in that the second slot is delayed by the first offset value compared to a target slot, and a slot index corresponding to the target slot is a maximum integer no greater than a first value, the first value being equal to a product of the slot index corresponding to the first slot being multiplied by a first ratio; the first ratio is equal to a quotient obtained from a first parameter power of 2 being divided by a second parameter power of 2, the first parameter being a subcarrier spacing parameter corresponding to the first cell, and the second parameter being equal to a subcarrier spacing parameter of the subcarrier spacing used by the cell to which the physical layer dynamic signaling belongs.

17. The method in the first node according to claim 15, characterized in that a minimum value of a scheduling delay between a channel scheduled by the first DCI and the first DCI in any cell among the K1 cells depends on the first minimum applicable scheduling offset; the first minimum applicable scheduling offset is applicable for K1 first-type slots in the K1 cells; each of the K1 first-type slots depends on the first slot, and the K1 first-type slots depend on K1 offset values respectively, the K1 offset values depending on K1 subcarrier spacings corresponding to the K1 cells respectively.

18. The method in the first node according to claim 15, characterized in comprising:
receiving a first PDCCH;
wherein the first PDCCH is transmitted in the first slot, the first PDCCH being the physical layer dynamic signaling used to indicate the first minimum applicable adjustment offset; the first PDCCH is earlier than the first DCI in time domain.

19. The method in the first node according to claim 15, characterized in comprising:
receiving a first signal;
wherein the first signal comprises K1 first-type sub-signals, the K1 first-type sub-signals being transmitted in the K1 cells, respectively; the first DCI is used to schedule the first signal; a minimum value of a scheduling delay between each of the K1 first-type sub-signals and the first DCI is no smaller than the first minimum applicable scheduling offset;
or,
transmitting a second signal;
wherein the second signal comprises K1 second-type sub-signals, the K1 second-type sub-signals being transmitted in the K1 cells, respectively; the first DCI is used to schedule the second signal; a minimum value of a scheduling delay between each of the K1 second-type sub-signals and the first DCI is no smaller than the first minimum applicable scheduling offset.

20. The method in the first node according to claim 15, characterized in that
the first receiver, receiving a first information block;
wherein the first information block indicates a first cell set, the first cell set comprising the K1 cells, the cells in the first cell set supporting scheduling by a DCI used to schedule multiple serving cells simultaneously.
